(19) United States
(12) Patent Application Publication
(10) Pub. No.: US 2026/0340293 A1
(43) Pub. Date: Oct. 29, 2026

(54) System and Method of Cross-Modal and Manifold-Aware Upsampling in Persistent Cognitive Machines with Visual Cortex Integration

(71) Applicant: AtomBeam Technologies Inc., Moraga, CA (US)

(72) Inventor: Brian Galvin, Silverdale, WA (US)

(21) Appl. No.: 19/385,396

(22) Filed: Nov. 11, 2025

Related U.S. Application Data
(63) Continuation-in-part of application No. 19/385,114, filed on Nov. 10, 2025.
Application No. 19/385,114 is a continuation-in-part of application No. 19/383,734, filed on Nov. 9, 2025.
Application No. 19/383,734 is a continuation-in-part of application No. 19/379,579, filed on Nov. 4, 2025.
Application No. 19/379,579 is a continuation-in-part of application No. 19/378,949, filed on Nov. 4, 2025.
Application No. 19/378,949 is a continuation-in-part of application No. 19/377,013, filed on Nov. 2, 2025.
Application No. 19/377,013 is a continuation-in-part of application No. 19/352,457, filed on Oct. 7, 2025.
Application No. 19/352,457 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/051,193 is a continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/657,719, filed on May 7, 2024, now Pat. No. 12,166,506.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 19/377,013 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025, now Pat. No. 12,699,883.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 19/378,949 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/379,579 is a continuation-in-part of application No. 19/363,675, filed on Oct. 21, 2025.
Application No. 19/363,675 is a continuation-in-part of application No. 19/351,286, filed on Oct. 6, 2025, now Pat. No. 12,724,976.
Application No. 19/351,286 is a continuation-in-part of application No. 19/321,173, filed on Sep. 6, 2025, now Pat. No. 12,602,549.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 19/383,734 is a continuation-in-part of application No. 19/329,369, filed on Sep. 15, 2025, now Pat. No. 12,670,331.
Application No. 19/329,369 is a continuation-in-part of application No. 19/328,199, filed on Sep. 14, 2025, now Pat. No. 12,645,884.
Application No. 19/328,199 is a continuation-in-part of application No. 19/328,179, filed on Sep. 14, 2025, now Pat. No. 12,670,330.
Application No. 19/328,179 is a continuation-in-part of application No. 19/326,730, filed on Sep. 12, 2025, now Pat. No. 12,608,555.
Application No. 19/328,199 is a continuation of application No. 19/328,103, filed on Sep. 13, 2025, now Pat. No. 12,639,521.
Application No. 19/328,103 is a continuation-in-part of application No. 19/326,730, filed on Sep. 12, 2025, now Pat. No. 12,608,555.
(63) Continuation-in-part of application No. 18/679,515, filed on May 31, 2024, now Pat. No. 12,469,179.
Application No. 18/679,515 is a continuation-in-part of application No. 18/537,728, filed on Dec. 12, 2023, now Pat. No. 12,058,333.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method of manifold-aware visual upsampling within a persistent cognitive machine architecture encodes visual input streams into latent trajectories in a Lorentzian manifold that preserves spatiotemporal causality through time-like constraints. The system computes a compression pressure field characterizing semantic density along the trajectories and performs manifold-constrained upsampling by densifying trajectories through insertion of intermediate points along geodesically valid paths, with allocation guided by the pressure field. Cross-modal correlation restores degraded content in one trajectory by exploiting structural information from another trajectory derived from a different modality or viewpoint, subject to geodesic distance constraints. Symbolic anchors mark semantically significant locations to guide prioritization of upsampling and restoration operations. The system decodes the upsampled and restored trajectories to generate enhanced visual output with improved resolution while maintaining temporal coherence, transforming upsampling from pixel interpolation into geometrically grounded trajectory densification.

### CROSS-REFERENCE TO RELATED APPLICATIONS

Priority is claimed in the application data sheet to the following patents or patent applications, each of which is expressly incorporated herein by reference in its entirety:
Ser. No. 18/679,515
Ser. No. 19/385,114
Ser. No. 19/383,734
Ser. No. 19/379,579
Ser. No. 19/378,949
Ser. No. 19/377,013
Ser. No. 19/352,457
Ser. No. 19/321,173
Ser. No. 19/284,115
Ser. No. 19/051,193
63/847,082
63/847,091
63/847,096
63/847,101
63/847,969
Ser. No. 19/038,801
Ser. No. 18/818,593
Ser. No. 18/657,719
Ser. No. 18/410,980
Ser. No. 18/537,728
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 19/328,094
Ser. No. 19/363,675
Ser. No. 19/351,286
Ser. No. 18/427,716
Ser. No. 19/329,369
Ser. No. 19/328,199
Ser. No. 19/328,179
Ser. No. 19/328,103

### BACKGROUND OF THE INVENTION

### Field of the Art

The present invention relates to the field of visual data processing and machine learning, and more specifically to manifold-based systems for visual upsampling, cross-modal restoration, and semantic-guided enhancement within persistent cognitive architectures.

### Discussion of the State of the Art

Visual super-resolution and data enhancement systems have traditionally relied on pixel-space interpolation methods such as bicubic or Lanczos resampling, or more recently on deep learning techniques including convolutional neural networks (CNNs), transformers, and generative adversarial networks (GANs). While these models have improved the apparent resolution of degraded or compressed imagery, they frequently operate frame-by-frame or patch-by-patch, without accounting for global geometric structure, semantic consistency, or temporal causality across sequences. This leads to perceptually inconsistent outputs, flicker artifacts, and hallucinated content that lacks grounding in scene semantics or physical plausibility.

Recent approaches in video processing and multimodal fusion attempt to integrate signals across time or sensing modalities (e.g., infrared, radar, visible light), but typically rely on feature-space alignment or late-stage fusion pipelines. These methods struggle under conditions of extreme degradation, occlusion, or loss due to compression. Moreover, they lack a unified geometric representation capable of supporting joint cross-modal correlation, scale-aware upsampling, and cognitive prioritization of detail restoration.

Existing machine learning pipelines also treat visual enhancement as a one-way process, lacking feedback from cognitive modules or memory systems. They are not designed to learn procedural strategies for restoration over time, nor do they support collaborative inference among distributed agents operating under privacy-preserving constraints. Generative enhancement, when used, often lacks mathematical grounding, violating geometric continuity or introducing temporal inconsistencies in sequence data.

What is needed is a system and method for visual upsampling and restoration that embeds multimodal input streams into a unified Lorentzian latent space, performs manifold-aware interpolation and augmentation constrained by temporal causality and curvature, leverages semantic anchors and pressure-driven prioritization, and integrates procedural memory, offline learning, and federated collaboration across persistent cognitive systems.

### SUMMARY OF THE INVENTION

The inventor has conceived and reduced to practice a system and method for geometrically guided upsampling and restoration of visual data using a Lorentzian manifold representation integrated within a persistent cognitive architecture. Visual input streams, including multimodal and multi-view data, are encoded into temporally coherent trajectories in curved latent space, where operations such as upsampling, correlation, augmentation, and semantic guidance are performed according to manifold geometry and cognitive significance. This approach enables reconstruction of enhanced visual outputs that preserve both temporal causality and semantic coherence, while supporting cross-modal data recovery, procedural learning, and federated collaboration across systems.

In an embodiment, a computer system is configured to encode visual input streams into latent trajectories in a Lorentzian manifold using encoders that enforce time-like constraints to preserve spatiotemporal causality. A compression pressure field is computed over the manifold to characterize semantic density along these trajectories. The system performs manifold-constrained upsampling by inserting intermediate points along geodesically valid paths, with densification guided by the pressure field. Cross-modal correlation is applied to restore degraded content in one trajectory using structural information from another trajectory of a different modality or viewpoint, while maintaining geodesic proximity. Symbolic anchors marking semantically important locations within the manifold guide prioritization of upsampling and restoration. The resulting trajectories are decoded to produce enhanced visual outputs with improved resolution and preserved temporal consistency.

In an aspect of an embodiment, the system applies generative augmentation to synthesize detail beyond original resolution by conditioning a generative model on manifold geometry and symbolic anchors. The generated content conforms to geodesic structure and causal ordering.

In an aspect of an embodiment, upsampling is performed using exponential map operations, which generate intermediate points by projecting tangent vectors from existing points on the latent trajectory.

In an aspect of an embodiment, the system routes trajectories among hierarchical subspaces representing macro, meso, and micro scales. Routing is based on compression pressure and supports bidirectional zoom operations that maintain semantic continuity across scales.

In an aspect of an embodiment, the system caches successful upsampling strategies associated with previously processed trajectories. When a new trajectory resembles a cached one geometrically or semantically, the corresponding strategy is retrieved and reused to reduce computational overhead.

In an aspect of an embodiment, the system engages in offline learning by applying stochastic perturbations to stored trajectories during idle periods, evaluating the resulting changes for coherence and quality, and incorporating successful strategies into the cache.

In an aspect of an embodiment, cached strategies are exported to remote systems as abstract manifold-level descriptions without transmitting visual data. Imported strategies are adapted through coordinate transformations to match the receiving system's local manifold structure.

In an aspect of an embodiment, the decoder and encoders are trained jointly using a composite loss function that includes terms for reconstruction accuracy, geodesic path smoothness, curvature regularization, and temporal coherence, each weighted according to system priorities.

In an aspect of an embodiment, the system's correlation operator includes cross-attention mechanisms that allow features from one latent trajectory to query and align with features from another, supporting structure-aware cross-modal restoration while maintaining geodesic integrity.

In an embodiment, a method is performed using the same manifold-aware encoding, upsampling, restoration, correlation, and decoding operations, executed by a computer system configured to carry out each of the above-described functions through software instructions stored on non-transitory machine-readable media.

### BRIEF DESCRIPTION OF THE DRAWING FIGURES

FIG. 1 is a block diagram illustrating an exemplary architecture of a cross-modal and manifold-aware upsampling system in persistent cognitive machines, in an embodiment. The system comprises interconnected subsystems for manifold embedding, cross-modal fusion, trajectory upsampling, restoration and augmentation, decoding, and cognitive integration.

FIG. 2 is a block diagram illustrating an exemplary manifold embedding system, in an embodiment. The system encodes degraded or multimodal input streams into causally ordered latent trajectories within a Lorentzian manifold while computing quality metrics.

FIG. 3 is a block diagram illustrating an exemplary cross-modal fusion and registration system, in an embodiment. The system registers and fuses multiple modality trajectories into a unified manifold representation using quality-weighted geodesic interpolation and computes semantic compression pressure.

FIG. 4 is a block diagram illustrating an exemplary cognitive integration and learning system, in an embodiment. The system manages symbolic anchors, caches successful strategies, performs offline exploration, and enables federated exchange of manifold-level processing strategies.

FIG. 5 is a block diagram illustrating an exemplary manifold decoding and reconstruction system, in an embodiment. The system transforms enhanced latent trajectories into pixel-space outputs and integrates a training optimizer to enable end-to-end system learning.

FIG. 6 is a flow diagram illustrating an exemplary method for cross-modal and manifold-aware upsampling in persistent cognitive machines, in an embodiment. The method includes trajectory encoding, pressure-guided upsampling, semantic prioritization, restoration, augmentation, and decoding.

FIG. 7 is a flow diagram illustrating an exemplary manifold-constrained upsampling method for densifying sparse trajectories through geodesically valid interpolation, in an embodiment.

FIG. 8 is a flow diagram illustrating an exemplary cross-modal restoration method for recovering degraded content using structural information from supporting modalities, in an embodiment.

FIG. 9 is a flow diagram illustrating an exemplary offline exploration and caching method for discovering improved upsampling strategies during idle periods, in an embodiment.

FIG. 10 is a flow diagram illustrating an exemplary generative augmentation method for synthesizing plausible detail beyond original capture resolution, in an embodiment.

FIG. 11 is a flow diagram illustrating an exemplary hierarchical scale routing method for dynamically allocating trajectories to appropriate resolution subspaces, in an embodiment.

FIG. 12 is a flow diagram illustrating an exemplary federated strategy exchange method for collaborative learning across multiple persistent cognitive machine instances, in an embodiment.

FIG. 13 is a flow diagram illustrating an exemplary joint training method for optimizing encoder, upsampler, restoration, and decoder parameters through end-to-end gradient descent, in an embodiment.

FIG. 14 illustrates an exemplary computing environment on which an embodiment described herein may be implemented.

### DETAILED DESCRIPTION OF THE INVENTION

The inventor has conceived and reduced to practice a system and method for manifold-aware visual upsampling and cross-modal fusion within a persistent cognitive machine architecture. The system receives compressed or degraded visual input streams, which may include video from multiple cameras, multimodal sensor data such as infrared and radar imagery, or other spatiotemporal data sources. Rather than performing conventional pixel-based interpolation, the system embeds input data into a Lorentzian latent manifold that preserves spatiotemporal causality, performs trajectory densification guided by geometric constraints and cognitive priorities, and reconstructs enhanced visual outputs. The system operates bidirectionally, processing external inputs for enhancement and generating visual outputs from internal cognitive states maintained by the persistent cognitive machine.

The core innovation distinguishes upsampling from pixel interpolation by treating it as geodesic trajectory densification in curved latent space. Visual sequences are represented as continuous trajectories evolving through a manifold with Lorentzian geometry, where temporal ordering is preserved through metric constraints. The system integrates upsampling operations with cognitive mechanisms including symbolic anchors that mark semantically important regions, thought bundles that cache successful processing strategies, and compression pressure fields that identify areas of high semantic density requiring prioritized processing. This integration transforms upsampling from an isolated enhancement step into a cognitively grounded process that allocates computational resources according to semantic relevance rather than uniform refinement across all regions.

The system comprises six interconnected subsystems that transform compressed visual input into enhanced output through a sequence of geometric and cognitive operations. A manifold embedding system transforms external visual and multimodal inputs into causally-ordered geodesic trajectories in Lorentzian latent space. A cross-modal fusion and registration system aligns and combines multiple modality trajectories into a unified geometric representation. A manifold-constrained trajectory upsampling system densifies sparse trajectories through geodesically-valid interpolation. A cross-modal restoration and augmentation system restores degraded content and synthesizes plausible detail beyond original resolution. A cognitive integration and learning system provides semantic guidance, caches strategies, and supports federated collaboration. A manifold decoding and reconstruction system transforms upsampled latent trajectories back to observable pixel-space outputs.

Data flows through the system along a forward path where compressed input X undergoes manifold embedding to produce quality-annotated latent trajectories, which are fused into a unified trajectory with an associated pressure field, then densified through geometric upsampling, restored and augmented through cross-modal correlation and generative synthesis, and finally decoded back to enhanced pixel-space output. The cognitive integration system provides bidirectional feedback by directing prioritization decisions in the upsampling and restoration systems based on symbolic anchors and cached strategies, while also engaging in offline exploration through a dreaming process that discovers improved processing strategies. A training loop propagates gradients from the decoder through all systems to improve encoder, upsampler, and decoder parameters based on composite loss functions that balance reconstruction fidelity with geometric validity.

The manifold embedding system transforms external visual and multimodal inputs into causally-ordered geodesic trajectories in Lorentzian latent space, preserving temporal causality and semantic structure while computing quality metrics for downstream fusion. The system receives compressed, degraded, or heterogeneous input streams that may vary in resolution, frame rate, compression codec, or sensing modality. An input normalization and decompression stage handles these heterogeneous formats by performing resolution scaling, temporal alignment, and codec-specific decompression to produce a degraded reconstruction denoted as X-hat. This preliminary reconstruction may contain compression artifacts, missing data, or degraded detail that subsequent stages address through manifold-aware processing.

A Lorentzian encoding stage applies encoders that map input tensors to trajectories in a Lorentzian manifold U. For a video or sensor stream represented as a tensor^{u} in the space of real-valued arrays with dimensions [symbol] × [symbol] × [symbol] ×ªc, where [symbol] denotes temporal length, [symbol] and [symbol] are spatial dimensions, and ªc is the number of channels, an encoder E maps this tensor to a trajectory ^{α}a(^{α}7) or γ(^{α}7) in the manifold^{U}. The encoding process may utilize three-dimensional convolutional architectures that process spatiotemporal patches while enforcing causal constraints. In an embodiment, the Lorentzian manifold is endowed with a metric tensor ª0 having signature [symbol] (−,+,+,\dots,+), distinguishing time-like from space-like dimensions. Temporal ordering is preserved by enforcing the time-like constraint:

[symbol]

\dot{γ}(t),\dot{γ}(t) [symbol] _{g}<0

where \dot{γ}(t) denotes the derivative of the trajectory γ(t) with respect to time and [symbol] ·,· [symbol] denotes the inner product induced by the metric g.

A geodesic trajectory generation stage applies the geodesic equation to trajectories produced by the encoder. In an embodiment, geodesic trajectories in the Lorentzian manifold are computed according to:

$$\frac{{d}^{2} {γ}^{i}}{{dt}^{2}} + {Γ}_{jk}^{i} \frac{d {γ}^{j}}{dt} \frac{d {γ}^{k}}{dt} = 0 where {Γ}_{jk}^{i}$$

are Christoffel symbols derived from the metric g. This formulation encodes the curvature of the manifold and ensures that trajectories evolve smoothly along geodesics rather than arbitrary paths.

A quality scoring stage computes reliability scores qᵢ(t) that characterize encoder fidelity, signal quality, and noise levels for each trajectory zᵢ(t). These scores may be derived from signal-to-noise ratios, confidence outputs of the encoder, or residual reconstruction error. In an embodiment, for each modality m∈ [symbol] , the input tensor x^{(m)}∈ [symbol] is mapped into a latent trajectory via an encoder:

γ^{(m)}(t)=E^{(m)}(x^{(m)})

Each encoder E^{(m)} is modality-specific but produces trajectories γ^{(m)}(t)∈ [symbol] that are geometrically compatible within a shared or aligned Lorentzian manifold [symbol] . The quality scores q^{(m)}(t) are associated with each modality's trajectory and used to weight their contributions during subsequent fusion operations.

The manifold embedding system outputs quality-annotated latent trajectories represented as pairs (zᵢ(t), qᵢ(t) for single-modality inputs, or (γ^{(m)}(t),q^{(m)}(t) for each modality m∈ [symbol] , where γ^{(m)}(t)∈ [symbol] is the encoded trajectory in the Lorentzian manifold and q^{(m)}(t) is the corresponding time-varying quality score. These annotated trajectories serve as the foundational data structures for all subsequent geometric and cognitive processing. By representing spatiotemporal input as continuous, causally ordered geodesic paths within a curved manifold, the system provides a mathematically rigorous substrate for manifold-aware upsampling that respects both geometric structure and temporal dynamics.

The cross-modal fusion and registration system aligns and combines multiple modality trajectories into a unified geometric representation, identifying semantically dense regions that require prioritized upsampling. The system receives quality-annotated trajectories from multiple sources, which may include different cameras viewing the same scene from different angles, different sensing modalities such as visible and infrared imagery, or different temporal captures of the same environment. These trajectories may initially reside in separate manifold spaces with different coordinate systems, requiring geometric registration before fusion can occur.

A registration map computation stage calculates transformations Rᵢⱼ that align trajectory i with trajectory j by minimizing cross-view distortion. In an embodiment, the registration map is computed as:

$${R}_{ij} = arg {min}_{R} {\sum }_{t} \qquad {d}_{ℳ}^{2} ( R ( {z}_{i} ( t ) ) , {z}_{j} ( t ) )$$

where [symbol] (·,·) denotes the geodesic distance in the manifold [symbol] . Symbolic anchors constrain this optimization by providing semantic correspondences.
An isometric embedding stage maps trajectories from individual fast manifolds

$${ℳ}_{i}^{( 1 )}$$

into a shared mesoscale manifold [symbol] via differentiable mappings φᵢ:

$${ℳ}_{i}^{( 1 )} \to {ℳ}_{2}$$

that preserve geometric structure. In an embodiment, these embeddings are trained to maintain local geodesic distances:

$${d}_{{ℳ}_{2}} ( {ϕ}_{i} ( z ) , {ϕ}_{i} ( {z}^{′} ) ) \approx {d}_{{ℳ}_{i}^{( 1 )}} ( z , {z}^{′} ) ∀ z , {z}^{′} ∈ {ℳ}_{i}^{( 1 )}$$

where [symbol] (·,·) denotes the geodesic distance on manifold [symbol] . The mappings φᵢ may be realized through neural networks optimized to preserve metric properties during the transition from fast (local) to mesoscale (shared) representations. This embedding process enables heterogeneous modality-specific trajectories to interact coherently within a unified geometric space.

A weighted geodesic interpolation stage computes a unified trajectory z_{f}(t) that represents the fusion of multiple registered and embedded trajectories. The fused trajectory is computed as:

$${z}_{f} ( t ) = arg {min}_{z} {\sum }_{i} \qquad {w}_{i} {d}_{ℳ}^{2} ( z , {ϕ}_{i} ( {z}_{i} ( t ) ) )$$

where φᵢ maps fast manifold

$${M}_{i}^{( 1 )}$$

to mesoscale manifold M₂, and the weights wᵢ∝qᵢ(t) are derived from the quality scores of each trajectory.

For multiple sensing modalities, a multimodal correlation operator applies a fusion function that aligns and combines modality-specific trajectories. In an embodiment, this is expressed as:

Γ(t)=R({γ^{(m)} [symbol] )

where γ^{(m)}(t)∈ [symbol] is the latent trajectory for modality m, and R(·) is a correlation function that produces a fused trajectory Γ(t)∈ [symbol] in the shared manifold. The operator R may be implemented using cross-attention mechanisms (where features from one modality query those of another), graph neural networks (where nodes represent modality embeddings and edges capture inter-modal dependencies), or transformer-based architectures that propagate fine-scale detail across modalities under manifold constraints. This fusion process leverages redundancy and complementarity across modalities to recover missing or degraded information in any individual channel.

A compression pressure computation stage analyzes the fused manifold to compute a scalar field P(z) that identifies semantically dense regions requiring prioritized upsampling. In an embodiment, the compression pressure is defined as:

P(z)=∥∇·\vec{v}(z)∥

where \vec{v}(z) is the latent velocity field representing the rate and direction of change in latent space around point z.

The cross-modal fusion and registration system outputs a unified fused trajectory-denoted as either z_{f}(t) or Γ(t)∈ [symbol] —within the shared mesoscale manifold [symbol] . This trajectory results from reliability-weighted geodesic fusion across modalities and viewpoints. Additionally, the system computes an associated compression pressure field P(z), defined as:

P(z)=∥∇·\vec{v}(z)∥

where \vec{v}(z) is the local latent velocity field in the manifold. The scalar field P(z) characterizes semantic density or structural complexity at each point along the fused trajectory, enabling prioritized upsampling. The output provides a single coherent representation that integrates information from all available sources, geometrically aligned and weighted by quality metrics for downstream manifold-aware processing.

The manifold-constrained trajectory upsampling system densifies sparse latent trajectories using geodesically valid interpolation techniques. It receives as input a fused trajectory z_{f}(t) or Γ(t)∈ [symbol] , along with an associated compression pressure field P(z), as computed by the fusion system. The trajectory may be sparsely sampled in time or space, consisting of a sequence of control points {z₀, z₁, . . . , z_{T}}⊂ [symbol] , which represent salient instants or keyframes. However, the lack of intermediate points between these controls precludes high-resolution reconstruction or temporally smooth playback. The system addresses this by inserting additional points along geodesics, prioritizing interpolation in regions where the pressure field satisfies P(z)>τ, for some semantic density threshold t, and dynamically selecting the appropriate hierarchical submanifold (e.g., [symbol] , [symbol] , [symbol] ) based on task requirements and semantic complexity.

An exponential map densification stage generates intermediate points along the trajectory by applying the exponential map operation. In an embodiment, intermediate points are computed as:

žₖ=exp_{z}_{ᵢ}(δv),v∈T_{z}_{ᵢ}

[symbol]

where T_{z}_{ᵢ} [symbol] is the tangent space of the manifold at zᵢ and δ controls the step size along the geodesic.

A tangent space computation stage calculates valid tangent vectors representing permissible directions for trajectory continuation. The tangent space is computed from the local metric tensor and may incorporate constraints from the geodesic equation to identify directions that maintain smooth evolution of the trajectory. The system may use parallel transport to transfer tangent vectors along the trajectory, maintaining their geometric properties while accounting for the curvature of the path. Tangent space computations provide the foundation for determining how to insert intermediate points that respect both the local geometry and the global structure of the manifold.

A compression pressure prioritization stage allocates densification resources preferentially to regions where the pressure field P(z) exceeds a predefined threshold t, i.e., where:

P(z)=∥∇·\vec{v}(z)∥>τ

This ensures that interpolation is concentrated in semantically dense regions—such as object boundaries, areas of rapid motion, or structural discontinuities—rather than uniformly along the trajectory. This adaptive allocation strategy enables the system to generate high-fidelity detail where it is cognitively or visually significant, while allowing coarser sampling in less critical regions to improve overall computational efficiency.

In conjunction with this prioritization, a hierarchical scale selection stage routes trajectory segments to different latent subspaces—denoted [symbol] , [symbol] , and [symbol] —based on zoom context, semantic complexity, and computational budget. A dynamic selector Σmaps each trajectory γ(t) to an appropriate resolution level:

Σ:{γ(t)}→ [symbol] ,where s∈{macro,meso,micro}

The macro scale captures global structure and coarse motion patterns; the meso scale focuses on object-level dynamics; and the micro scale supports pixel-level texture and fine-detail synthesis. This dynamic routing ensures that content is processed at the appropriate level of abstraction for each portion of the trajectory.

A bidirectional zoom operation stage supports both zoom-in and zoom-out operations as dual geometric processes. In an embodiment, zoom operations are expressed as:

z_{zoomed}=γ(t)+δ,δ∈T_{γ(t)}

[symbol]

z_{coarse}=π(z),π: [symbol] →

[symbol]

where z_{zoomed} moves trajectories into higher-resolution fiber bundles and z_{coarse} projects trajectories to coarser subspaces.

A causal constraint verification stage ensures that all upsampled trajectories preserve temporal ordering by enforcing the Lorentzian time-like condition:

[symbol]

\dot{γ}(t),\dot{γ}(t) [symbol] _{g}<0

for each interpolated point γ(t), where \dot{γ}(t) is the time derivative of the trajectory and [symbol] ·,· [symbol] _{g} is the inner product defined by the Lorentzian metric g. Any intermediate point violating this inequality is discarded to prevent retrocausal or non-physical transitions.

A geodesic continuity enforcement stage verifies that the interpolated trajectory remains smooth and valid by checking that the geodesic equation holds locally:

$$\frac{{d}^{2} {γ}^{i}}{{dt}^{2}} + {Γ}_{jk}^{i} \frac{d {γ}^{j}}{dt} \frac{d {γ}^{k}}{dt} \approx 0$$

This condition ensures that inserted points adhere to the manifold's curvature structure, where

$${Γ}_{jk}^{i}$$

are Christoffel symbols computed from the metric.

The manifold-constrained trajectory upsampling system outputs a densified trajectory ž(t)⊂ [symbol] , comprising interpolated points that lie on valid geodesics, satisfy causal constraints, and are concentrated in high-pressure regions as determined by P(z). This trajectory serves as a geometrically consistent and semantically prioritized foundation for subsequent stages such as cross-modal restoration and generative augmentation.

The cross-modal restoration and augmentation system restores degraded content and synthesizes plausible detail beyond original resolution using cross-modal correlations and generative synthesis while respecting manifold geometric constraints. The system receives densified trajectories from the upsampling system, which may contain regions that remain degraded despite geometric interpolation, such as occluded areas visible in only one modality, content corrupted by compression artifacts, or regions that lack sufficient high-frequency detail for the target resolution.

A cross-modal correlation and restoration stage applies a cross-modal upsampling operator for cases where a degraded modality a can be enhanced using information from a supporting modality b. In an embodiment, the operator is defined as:

\tilde{γ}^{(a)}(t)=U_{a|b}(γ^{(a)}(t),γ^{(b)}(t))

subject to the constraint:

d(\tilde{γ}^{(a)}(t),γ^{(b)}(t)<∈

where d(·,·) denotes the geodesic distance within the shared manifold, and ∈ is a threshold ensuring the restored trajectory remains consistent with the supporting modality.

An occlusion detection stage identifies regions in one modality that are hidden or degraded but visible in other modalities. Detection may be performed by analyzing reconstruction error, checking for missing data regions, or identifying areas where quality scores fall below threshold values. Once occlusions are detected, cross-attention mechanisms query features from supporting modalities to inform reconstruction of the occluded regions. The cross-attention layers allow the system to selectively incorporate relevant information from non-occluded modalities while maintaining the geometric structure and semantic content appropriate to the target modality. This selective incorporation avoids simple copying of content across modalities, instead performing a geometrically-aware transfer that respects the distinct characteristics of each sensing mode.

A geodesic distance constraint enforcement stage validates that restored content remains geometrically consistent with supporting modalities by checking that pairwise geodesic distances remain within acceptable bounds. When multiple supporting modalities are available, the system may compute a consensus restoration that balances information from all sources while maintaining geodesic proximity to each. This consensus approach reduces the risk of introducing artifacts or inconsistencies that might arise from relying too heavily on a single supporting modality.

A generative augmentation stage applies a generative operator to synthesize plausible detail at scales finer than the original capture resolution. In an embodiment, the operator is expressed as:

\hat{z}=G(z,η),η~ [symbol] (0,I)

where G denotes a generative model (e.g., latent diffusion), η is a stochastic input sampled from a standard normal distribution, and ž is the augmented latent state that incorporates plausible fine-scale detail.

A semantic conditioning stage conditions the generative process on symbolic anchors and local context to maintain plausibility. When a symbolic anchor indicates that a region contains a face, for example, the generative augmentation produces detail consistent with facial structure rather than arbitrary textures. Conditioning may be implemented through class labels, textual descriptions, or latent embeddings that capture semantic categories and attributes. This conditioning bridges geometric and semantic constraints, producing synthesized detail that is both geometrically consistent with the manifold trajectory and semantically appropriate for the content category.

A manifold constraint respect stage checks that generated details remain on valid geodesics and preserve causal ordering. The generative augmentation process introduces new content, but this content must still satisfy the fundamental geometric constraints of the Lorentzian manifold. The system verifies that synthesized trajectories maintain the time-like constraint and that new detail points lie within the tangent space of the manifold at appropriate base points. This verification prevents the generator from producing geometrically impossible content that would be rejected by downstream processing or that would introduce inconsistencies with other parts of the trajectory.

A multi-scale synthesis stage generates textures, micro-motions, and surface detail at multiple hierarchical scales. Rather than synthesizing all detail at a single resolution, the system may first generate intermediate-scale features and then recursively refine them to produce finer detail. This hierarchical approach mirrors the structure of the manifold's macro, meso, and micro subspaces and allows the system to maintain semantic consistency across scales by conditioning fine-scale synthesis on the structure of coarser scales.

The cross-modal restoration and augmentation system outputs a restored and augmented trajectory \hat{z}(t)∈ [symbol] , where each point has been refined through a combination of manifold-constrained upsampling, cross-modal correlation, and generative augmentation. This trajectory incorporates, enhanced spatial and temporal resolution, reconstructed occlusions via supporting modalities, and synthesized detail produced by the generative operator:

\hat{z}(t)=G(z(t),η),η~ [symbol] (0,I)

The resulting trajectory satisfies both the causal constraint:

[symbol]

Ż(t),\dot{\hat{z}}(t) [symbol] _{g}<0

and geodesic consistency through constrained fusion:

d(\hat{γ}^{(a)}(t),γ^{(b)}(t)<∈

for any restored modality a using support from modality b. The trajectory \hat{z}(t) thus forms a high-fidelity latent representation that is geometrically valid, semantically enriched, and ready for decoding into pixel space in the final reconstruction stage.

The cognitive integration and learning system connects visual upsampling to the broader cognitive architecture of the persistent cognitive machine through symbolic anchors that direct prioritization, thought bundles that cache successful strategies, dreaming processes that enable offline exploration, and federated exchange mechanisms that support collaborative learning across multiple machine instances. The system operates continuously in parallel with the other subsystems, providing guidance during real-time processing and engaging in exploratory learning during idle periods.

A symbolic anchor management stage maintains a set of anchor pairs:

[symbol]

={(tᵢ,sᵢ)}

where each tᵢ denotes a point in the trajectory γ(t), and sᵢ is a semantic label such as “face,” “vehicle,” “motion onset,” or “scene transition.” These symbolic anchors guide prioritization by signaling to the upsampling and restoration systems which regions of the trajectory are cognitively or semantically significant. When computational resources are limited, the system uses [symbol] to allocate finer-grained processing (e.g., densification or augmentation) to anchor-linked segments, while applying coarser reconstruction elsewhere.

A thought bundle caching stage maintains a mapping from trajectories to processing strategies:

γ(t) [symbol] S(γ)

where S(γ) encodes the configuration of successful upsampling and restoration operations previously applied to γ(t). When a new trajectory γ′(t) is encountered, the system searches the cache for prior trajectories γ(t) that are similar under a manifold distance metric:

[symbol]

(γ′(t),γ(t))<δ

and reuses or adapts S(γ) accordingly. Alternatively, semantic similarity may be determined using learned embeddings or latent classifiers. This caching mechanism serves as a form of procedural memory, enabling efficient reuse of effective strategies and accelerating response to recurring visual patterns or degradation types.

A dreaming and perturbation stage operates during idle cycles when the system is not processing real-time input. During dreaming, the system applies stochastic perturbations to stored trajectories. In an embodiment, perturbations are defined as:

z′=Z+∈,∈~ [symbol] (0,Σ)

where z is a latent state, ∈ is a zero-mean Gaussian perturbation with covariance Σ, and z′ is the perturbed latent state. The perturbed trajectories are then evaluated for coherence and utility. The system may also recombine archived trajectories to explore counterfactual processing paths. In an embodiment, recombination is expressed as:

γ_{dream}(t)~G(γ₁(t),γ₂(t), . . . )

where G is a stochastic geodesic recombinator that blends features from multiple archived trajectories γᵢ(t) to form a novel trajectory γ_{dream}(t).

A strategy evaluation and incorporation stage assesses the coherence and fidelity of results produced during dreaming by computing reconstruction quality metrics, checking geometric validity, and comparing synthesized results against learned priors for plausibility. Successful discoveries, meaning perturbations or recombinations that produce improvements in quality or reveal new effective processing strategies, are incorporated into the thought bundle cache for future use. This offline learning process enables the system to improve its processing capabilities during periods when it would otherwise be idle, gradually expanding its repertoire of effective strategies for handling diverse types of degraded input.

A federated strategy exchange stage supports collaborative learning across multiple persistent cognitive machine instances by exporting manifold-level strategy descriptions S of gamma without transmitting pixel data. The exported strategies describe geometric operations, parameter configurations, and semantic conditioning approaches in an abstract form that can be imported by remote machines and adapted to their local manifold structures. Import operations apply fiber map transformations to translate strategies from one machine's manifold coordinate system to another's, accounting for differences in encoder architectures or training data while preserving the core geometric principles of the strategy. The system may weight contributions by source reliability, giving greater influence to strategies exported by machines that have demonstrated high performance or that operate in similar environments.

An integration with broader cognitive structures stage links visual anchors to the persistent cognitive machine's reasoning systems, enabling queries such as retrieve trajectories near goalpost or find video segments containing vehicles. This integration allows visual processing to be guided by higher-level goals and plans maintained by the cognitive architecture, transforming the visual cortex from an isolated enhancement pipeline into a component of a larger system capable of directed attention, memory-based reasoning, and goal-driven perception. The visual cortex can provide enhanced visual detail on demand to support reasoning tasks, or it can generate visual outputs that represent internally simulated scenarios for planning and counterfactual reasoning.

The cognitive integration and learning system outputs several forms of guidance and knowledge that influence other subsystems. Anchor-guided upsampling priorities direct the trajectory upsampling and restoration systems to concentrate resources on semantically important regions. A reusable strategy library reduces redundant computation by allowing successful processing configurations to be retrieved and adapted rather than rediscovered. Improved generalization from offline exploration expands the system's ability to handle novel types of degradation or previously unseen combinations of modalities. A distributed knowledge base across the persistent cognitive machine federation provides collective intelligence that exceeds what any individual instance could achieve through isolated learning.

The manifold decoding and reconstruction system transforms restored and augmented latent trajectories \hat{z}(t)∈ [symbol] back into observable pixel-space outputs. These trajectories—generated through manifold-aware densification and generative augmentation—are defined in

Lorentzian latent space and must be mapped to a conventional tensor representation for visualization or further processing.

An inverse manifold mapping stage applies a decoder:

R: [symbol] →

[symbol]

which reconstructs pixel-space sequences from manifold-encoded latent states. The decoder R may be realized as a deep neural network trained to invert the encoding transformation E, and may consist of deconvolutional (transposed convolution) or learned upsampling layers that expand spatial resolution progressively. Architecturally, the decoder may incorporate skip connections or cross-attention mechanisms to preserve high-frequency details by referencing earlier encoding stages. The reconstructed output \tilde{X}=R(\hat{z}(t)) corresponds to a temporally coherent, spatially enhanced video sequence suitable for human consumption or machine vision tasks.

A generative frame synthesis stage incorporates upsampled and augmented detail through learned decoder networks. Because the trajectory may contain interpolated points from exponential map operations and synthesized detail from generative augmentation, the decoder must be capable of translating these constructed latent representations into plausible pixel patterns. The decoder is trained jointly with the encoder and upsampler to maintain consistency between latent and pixel representations, so that geometrically valid latent trajectories correspond to visually coherent frame sequences. The training process may use adversarial losses or perceptual losses that encourage the decoder to produce frames that are indistinguishable from real captured video.

A temporal consistency enforcement stage applies constraints to maintain smooth frame-to-frame transitions in the decoded output. Temporal consistency may be enforced through optical flow alignment, where the system computes motion vectors between consecutive frames and penalizes deviations from smooth flow fields. Alternatively or additionally, the system may use recurrent connections in the decoder that carry information forward in time, allowing each frame to be conditioned on its predecessors. These mechanisms reduce temporal flicker and maintain the smooth motion characteristics that the geodesic trajectory representation is designed to preserve.

A multi-resolution rendering stage generates outputs at arbitrary target resolutions beyond the original capture resolution. The decoder may include multiple output heads that produce frames at different scales, or it may use progressive refinement where an initial coarse frame is iteratively enhanced to reach the target resolution. Because the latent trajectory has been densified and augmented with synthesized detail, the decoder can produce output resolutions that exceed the input resolution by substantial factors, potentially enabling continuous zoom operations where the user can smoothly transition from the original capture scale to much finer detail generated through the upsampling and augmentation processes.

A bidirectional operation capability supports both decoding external inputs and generating visual outputs from internal persistent cognitive machine cognitive states. When processing external input, the decoder operates in the forward path described above, transforming enhanced latent trajectories back to pixel space for display or downstream use.

When generating outputs from internal states, the cognitive architecture of the machine formulates a latent trajectory representing an imagined scene or counterfactual scenario, and the decoder renders this internal trajectory to produce visible video. This bidirectional capability allows the visual cortex to serve as both a perceptual system for understanding external inputs and a generative system for visualizing internal cognitive processes.

A latency optimization stage utilizes parallel processing on graphics processing unit or tensor processing unit hardware to achieve end-to-end latency on the order of less than one hundred milliseconds for real-time operation. The decoding process may be decomposed into independent operations on spatial tiles or temporal segments that can be processed in parallel. The system may also use approximation techniques such as reduced-precision arithmetic or pruned network architectures that trade modest accuracy for substantial speedup. Real-time latency supports applications such as live video enhancement, augmented reality displays, or interactive exploration of captured scenes where users require immediate visual feedback.

A training integration stage couples the decoder to a composite loss function optimizer that trains the entire system end-to-end. In an embodiment, the total loss is defined as:

[symbol]

= [symbol] +λ₁ [symbol] +λ₂ [symbol] +λ₃

[symbol]

where:
[symbol] is a reconstruction loss measuring fidelity between input and output (e.g., pixel-wise or perceptual loss),
[symbol] penalizes deviations from geodesic smoothness,
[symbol] regularizes manifold curvature to prevent distortion, and
[symbol] enforces temporal consistency, for example, via optical flow alignment.

The weighting coefficients λ₁, λ₂, λ₃ control the influence of each regularization term based on task-specific priorities. During training, gradients of the total loss with respect to decoder parameters flow backward through the decoder, then through the restoration and upsampling systems, and finally to the encoder, allowing all components to be jointly optimized to work coherently as an integrated pipeline.

The manifold decoding and reconstruction system outputs an enhanced visual stream denoted as X-tilde that exhibits improved resolution relative to the input, restored occlusions that were filled using cross-modal information, synthesized detail generated through augmentation processes, and maintained causal and semantic coherence through geometric constraints and temporal consistency enforcement. The output stream may be rendered for human viewing, provided to machine vision systems for object detection or scene understanding, or fed back into the persistent cognitive machine's cognitive processes for memory storage or reasoning operations. The decoder's ability to operate bidirectionally and support multiple output resolutions makes the visual cortex a flexible interface between the manifold-based cognitive architecture and the pixel-based world of conventional visual computing.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### DEFINITIONS

As used herein, “Lorentzian manifold” refers to a differentiable manifold equipped with a metric tensor of signature (−, +, +, . . . , +), which distinguishes time-like from space-like directions and enables the preservation of spatiotemporal causality in latent trajectory representations.

As used herein, “latent trajectory” refers to a temporally ordered sequence of encoded representations evolving through a latent space, where each point corresponds to an embedded state of visual or multimodal input at a given time.

As used herein, “geodesically valid path” refers to a curve within a manifold that satisfies the geodesic equation under the manifold's metric, representing the shortest or extremal path between points while maintaining consistency with the underlying curvature and geometry.

As used herein, “compression pressure” refers to a scalar field computed over a latent manifold that reflects the local semantic density or structural complexity of trajectory segments, and may guide the allocation of upsampling or restoration resources.

As used herein, “symbolic anchor” refers to a semantic annotation associated with a point or segment of a latent trajectory, where the annotation identifies cognitively or perceptually significant content such as faces, vehicles, text, or scene transitions.

As used herein, “cross-modal correlation” refers to the process of aligning and integrating information from multiple sensing modalities (e.g., visible light, infrared, radar) within a shared latent manifold to restore, augment, or enhance degraded content.

As used herein, “generative augmentation” refers to the process of synthesizing new detail or content beyond the original resolution of captured input data, by applying a generative model conditioned on manifold geometry, symbolic anchors, or semantic context.

As used herein, “thought bundle” refers to a stored representation of a previously processed trajectory and its associated processing configuration, which may be retrieved and reused as a cached strategy during future trajectory processing.

As used herein, “manifold-level strategy” refers to a description of a processing configuration that operates in latent space and includes geometric operations, routing decisions, and semantic conditions, without requiring transmission of raw visual input data.

As used herein, “geodesic continuity” refers to the property of a latent trajectory or augmentation result whereby interpolated or synthesized points conform to the smooth evolution dictated by the manifold's curvature and geodesic structure.

As used herein, “causal ordering” refers to the preservation of time-like progression in latent trajectories, such that each point adheres to constraints that prevent retrocausal or temporally inconsistent transitions, based on the manifold's metric.

As used herein, “zoom operation” refers to a geometric transformation that projects a latent trajectory into a higher-resolution subspace (zoom-in) or lower-resolution subspace (zoom-out), while maintaining semantic and geometric coherence across scales.

As used herein, “federated strategy exchange” refers to the privacy-preserving transmission and adaptation of abstract processing strategies among distributed cognitive machine instances, without exchanging raw visual data.

Conceptual Architecture of a Cross-Modal and Manifold-Aware Upsampling System in Persistent Cognitive Machines with Visual Cortex Integration

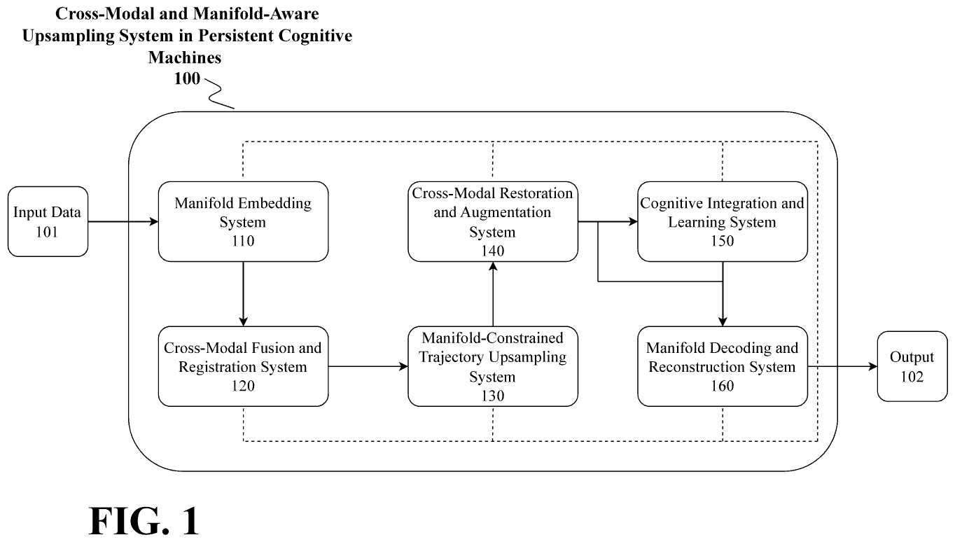

FIG. 1 is a block diagram illustrating exemplary architecture of a cross-modal and manifold-aware upsampling system in persistent cognitive machines with visual cortex integration, in an embodiment. The system 100 as illustrated comprises six interconnected subsystems that transform compressed or degraded visual input into enhanced output through a sequence of geometric and cognitive operations.

Visual input streams 101, which may include video from multiple cameras, multimodal sensor data such as infrared and radar imagery, or other spatiotemporal data sources, enter a manifold embedding system 110 that encodes the input into causally-ordered geodesic trajectories in Lorentzian latent space. The manifold embedding system 110 produces quality-annotated latent trajectories that characterize the fidelity and reliability of each encoded stream, providing downstream systems with information about which sources may contain more reliable structural information for restoration operations.

The quality-annotated latent trajectories flow from the manifold embedding system 110 to a cross-modal fusion and registration system 120 that aligns and combines multiple modality trajectories into a unified geometric representation. The cross-modal fusion and registration system 120 applies registration transformations to minimize cross-view distortion, embeds trajectories from individual fast manifolds into a shared mesoscale manifold, and performs quality-weighted geodesic interpolation to produce a single fused trajectory. The cross-modal fusion and registration system 120 also computes a compression pressure field that characterizes semantic density at points along the fused trajectory by analyzing the divergence of the latent velocity field, identifying regions where rapid changes in latent space representation may indicate semantically significant content such as object boundaries, areas of rapid motion, or structural discontinuities.

The unified fused trajectory and associated pressure field pass from the cross-modal fusion and registration system 120 to a manifold-constrained trajectory upsampling system 130 that densifies sparse trajectories through geodesically valid interpolation. The manifold-constrained trajectory upsampling system 130 inserts intermediate points along geodesics using exponential map operations, allocates densification resources preferentially to regions where the compression pressure field exceeds a threshold, and dynamically routes trajectory segments to hierarchical subspaces representing macro, meso, and micro scales based on semantic complexity and computational budget. The manifold-constrained trajectory upsampling system 130 verifies that all interpolated points satisfy time-like constraints and maintain geodesic continuity according to the Lorentzian metric structure, producing a densified trajectory with increased temporal and spatial sampling along geometrically valid paths.

The densified trajectory flows from the manifold-constrained trajectory upsampling system 130 to a cross-modal restoration and augmentation system 140 that restores degraded content and synthesizes plausible detail beyond original resolution. The cross-modal restoration and augmentation system 140 applies cross-modal correlation to restore occluded or degraded regions in one trajectory using structural information from supporting trajectories of different modalities, subject to geodesic distance constraints that maintain geometric consistency. The cross-modal restoration and augmentation system 140 also applies generative augmentation by conditioning a generative model on manifold geometry and symbolic anchors to synthesize fine-scale detail that respects geodesic continuity and causal ordering, producing a restored and augmented trajectory with enhanced resolution, reconstructed occlusions, and synthesized textures or micro-motions at multiple hierarchical scales.

A cognitive integration and learning system 150 operates in parallel with the other subsystems, providing bidirectional feedback and guidance throughout the processing pipeline.

The cognitive integration and learning system 150 maintains symbolic anchors that mark semantically significant locations within the manifold, directing the manifold-constrained trajectory upsampling system 130 and cross-modal restoration and augmentation system 140 to prioritize processing in regions containing faces, vehicles, text, or other cognitively salient content. The cognitive integration and learning system 150 also maintains a cache of successful upsampling strategies associated with previously processed trajectories, retrieves and adapts these strategies when geometrically or semantically similar trajectories are encountered, and performs offline exploration during idle periods by applying stochastic perturbations to stored trajectories and incorporating successful discoveries into the strategy cache. The cognitive integration and learning system 150 supports federated collaboration by exporting manifold-level strategy descriptions to remote persistent cognitive machine instances without transmitting pixel data, and imports strategies from remote systems by applying coordinate transformations to adapt them to the local manifold structure.

The restored and augmented trajectory flows from the cross-modal restoration and augmentation system 140 to a manifold decoding and reconstruction system 160 that transforms latent representations back into observable pixel-space outputs 102. The manifold decoding and reconstruction system 160 applies an inverse manifold mapping that reconstructs video sequences from manifold-encoded latent states, incorporates upsampled and augmented detail through learned decoder networks, and applies temporal consistency constraints to maintain smooth frame-to-frame transitions. The manifold decoding and reconstruction system 160 supports multi-resolution rendering to generate outputs at arbitrary target resolutions beyond the original capture resolution, operates bidirectionally to support both enhancement of external inputs and generation of visual outputs from internal cognitive states maintained by the persistent cognitive machine, and achieves end-to-end latency on the order of less than one hundred milliseconds through parallel processing on graphics processing unit hardware for real-time operation. The manifold decoding and reconstruction system 160 is coupled to a training optimization process that propagates gradients backward through all subsystems using a composite loss function comprising reconstruction fidelity, geodesic smoothness, curvature regularization, and temporal coherence terms, allowing joint optimization of encoders, upsampling operations, restoration operations, and decoders to work coherently as an integrated pipeline.

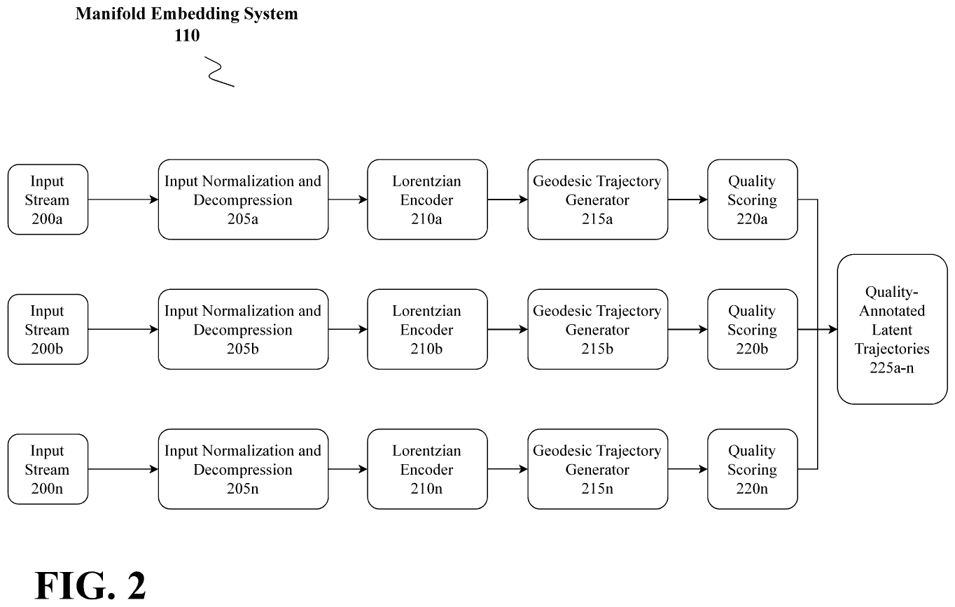

FIG. 2 is a block diagram illustrating an exemplary manifold embedding system 110 that transforms external visual and multimodal inputs into causally-ordered geodesic trajectories in Lorentzian latent space, in an embodiment. Visual input streams 200a,b-n, which may include compressed video sequences, degraded sensor data, or heterogeneous multimodal captures varying in resolution, frame rate, compression codec, or sensing modality, enter an input normalization and decompression stage 205 a,b-n that handles format heterogeneity through resolution scaling, temporal alignment, and codec-specific decompression operations. The input normalization and decompression stage 205 a-n produces a degraded reconstruction that may contain compression artifacts, missing data, or reduced detail, providing a standardized input representation for subsequent encoding operations.

The normalized input flows from the input normalization and decompression stage 205 a-n to a Lorentzian encoding stage 210 a,b-n that applies one or more encoders to map input tensors to trajectories in a Lorentzian manifold. The Lorentzian encoding stage 210 a-n may utilize three-dimensional convolutional architectures that process spatiotemporal patches while enforcing causal constraints through the manifold metric structure, transforming tensors with dimensions representing temporal length, spatial extent, and channel count into latent trajectories that evolve through a manifold with Lorentzian geometry. The Lorentzian encoding stage 210 a-n enforces time-like constraints on trajectory evolution by requiring that the inner product of the trajectory derivative with itself under the Lorentzian metric remains negative, distinguishing time-like dimensions from space-like dimensions and preserving temporal ordering in the latent representation.

The encoded trajectories pass from the Lorentzian encoding stage 210 a-n to a geodesic trajectory generation stage 215 a,b-n that applies the geodesic equation to trajectories produced by the encoder. The geodesic trajectory generation stage 215 a-n computes Christoffel symbols derived from the metric tensor and applies the geodesic equation to verify or adjust trajectory evolution, providing trajectories that evolve smoothly along geodesics according to the curvature of the manifold rather than following arbitrary paths through latent space. The geodesic trajectory generation stage 215 a-n may utilize numerical integration methods or learned components that approximate geodesic solutions while maintaining computational efficiency for real-time processing requirements.

The geodesically valid trajectories flow from the geodesic trajectory generation stage 215 a-n to a quality scoring stage 220 a,b-n that computes reliability scores characterizing encoder fidelity, signal quality, and noise levels for each trajectory. The quality scoring stage 220 a-n may derive scores from signal-to-noise ratios computed in the input space, confidence outputs generated by the encoder network during the encoding process, or residual reconstruction error measured by encoding and then decoding the input to assess information preservation. For multimodal inputs, the quality scoring stage 220 a-n generates separate quality scores for each modality trajectory, allowing downstream fusion operations to weight contributions according to the relative reliability of different sensing modes or capture conditions.

The manifold embedding system 110 outputs quality-annotated latent trajectories 225a,b-n represented as pairs associating each trajectory point with a corresponding time-varying quality score. For single-modality inputs, the output comprises trajectory and quality score pairs where the trajectory represents the encoded path through the Lorentzian manifold and the quality score characterizes local fidelity. For multimodal inputs, the output comprises separate trajectory and quality score pairs for each modality, where each modality-specific encoder produces trajectories that are geometrically compatible within a shared or aligned manifold structure despite originating from different sensing modes. The quality-annotated latent trajectories 225a-n serve as foundational data structures for subsequent geometric and cognitive processing operations, representing spatiotemporal input as continuous, causally ordered geodesic paths within curved manifold space that support manifold-aware upsampling operations respecting both geometric structure and temporal dynamics.

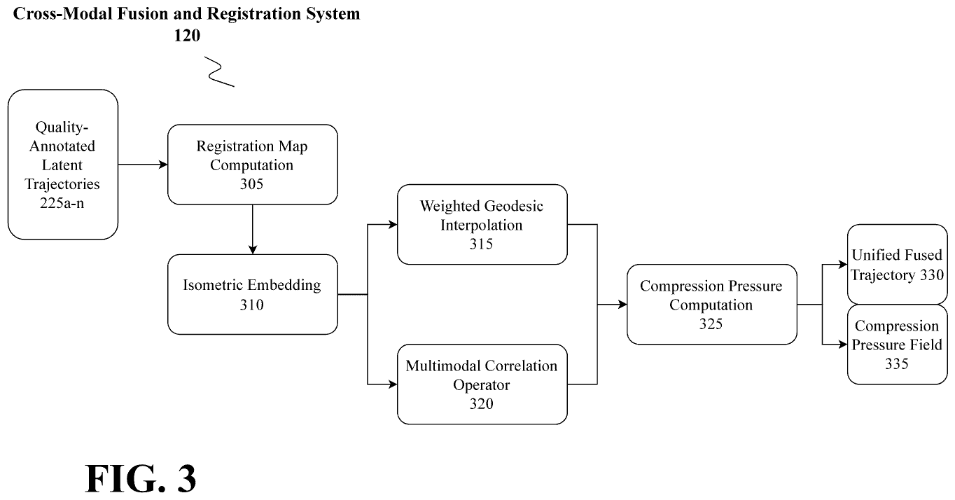

FIG. 3 is a block diagram illustrating an exemplary cross-modal fusion and registration system 120 that aligns and combines multiple modality trajectories into a unified geometric representation, in an embodiment. Quality-annotated latent trajectories 225a-n from multiple sources, which may include different cameras viewing a scene from different angles, different sensing modalities such as visible and infrared imagery, or different temporal captures of an environment, enter a registration map computation stage 305 that calculates transformations to align trajectories by minimizing cross-view distortion. The registration map computation stage 305 may compute registration maps by minimizing the sum of squared geodesic distances between corresponding points on trajectories after transformation, where symbolic anchors provide semantic correspondences that constrain the optimization process by identifying points that should align across different views or modalities.

The registered trajectories flow from the registration map computation stage 305 to an isometric embedding stage 310 that maps trajectories from individual fast manifolds into a shared mesoscale manifold via differentiable mappings. The isometric embedding stage 310 applies mappings that preserve geometric structure by maintaining local geodesic distances during the transition from fast manifold representations to the shared mesoscale space, allowing heterogeneous modality-specific trajectories to interact coherently within a unified geometric framework. The isometric embedding stage 310 may realize these mappings through neural networks optimized to preserve metric properties, supporting subsequent fusion operations that require trajectories from different sources to occupy compatible coordinate systems within the shared manifold.

The embedded trajectories pass from the isometric embedding stage 310 to a weighted geodesic interpolation stage 315 that computes a unified trajectory representing the fusion of multiple registered and embedded trajectories. The weighted geodesic interpolation stage 315 computes the fused trajectory by minimizing a weighted sum of squared geodesic distances between a candidate fusion point and each of the embedded input trajectories, where weights are derived from the quality scores associated with each trajectory to give greater influence to more reliable sources. The weighted geodesic interpolation stage 315 produces a single coherent trajectory that integrates information from all available sources according to their relative reliability, leveraging redundancy and complementarity across modalities to recover missing or degraded information in any individual channel.

For multimodal inputs, a multimodal correlation operator stage 320 applies a fusion function that aligns and combines modality-specific trajectories through cross-attention mechanisms, graph neural networks, or transformer-based architectures. The multimodal correlation operator stage 320 may implement cross-attention where features from one modality query those of another, allowing fine-scale detail to propagate across modalities under manifold constraints, or may use graph representations where nodes represent modality embeddings and edges capture inter-modal dependencies. The multimodal correlation operator stage 320 produces a fused trajectory that exploits structural relationships between modalities, supporting recovery of occluded or degraded content by transferring information from sensing modes where the content remains visible or well-preserved.

The fused trajectory flows from the weighted geodesic interpolation stage 315 or multimodal correlation operator stage 320 to a compression pressure computation stage 325 that analyzes the fused manifold to compute a scalar field identifying semantically dense regions. The compression pressure computation stage 325 may compute the compression pressure by calculating the divergence of the latent velocity field, which represents the rate and direction of change in latent space around each point, producing a scalar value that characterizes local semantic density or structural complexity. The compression pressure computation stage 325 may alternatively or additionally compute pressure metrics based on Ricci curvature or other geometric properties of the manifold that indicate regions where the latent representation exhibits rapid variation corresponding to semantically significant content boundaries.

The cross-modal fusion and registration system 120 outputs a unified fused trajectory 330 within the shared mesoscale manifold along with an associated compression pressure field 335.

The unified fused trajectory 330 results from reliability-weighted geodesic fusion across modalities and viewpoints, providing a single coherent representation that integrates information from all available sources and has been geometrically aligned and weighted by quality metrics. The compression pressure field 335 characterizes semantic density or structural complexity at each point along the fused trajectory, supporting prioritized upsampling operations by identifying regions where high pressure values may indicate object boundaries, motion events, or other content requiring enhanced processing. The outputs provide a geometrically unified representation and a cognitive priority map for downstream manifold-aware processing operations that can allocate computational resources according to semantic relevance rather than applying uniform refinement across all regions.

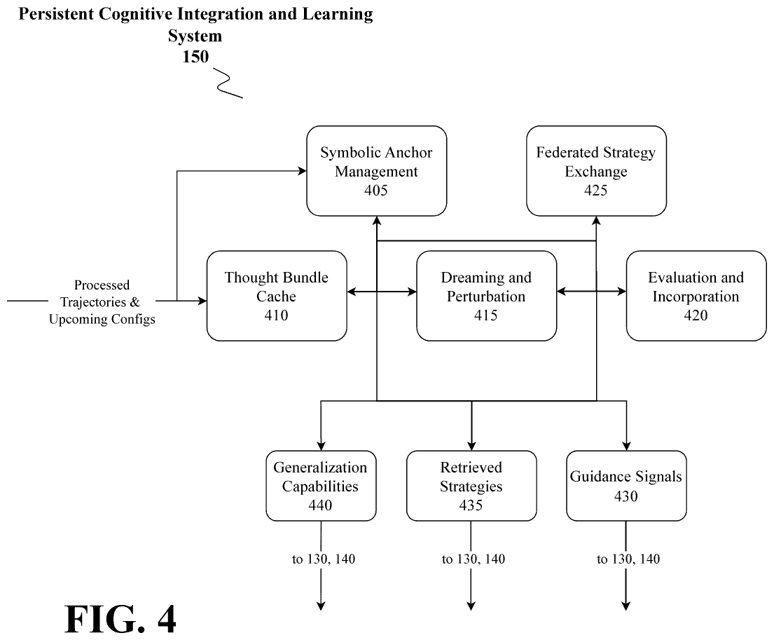

FIG. 4 is a block diagram illustrating an exemplary cognitive integration and learning system 150 that connects visual upsampling operations to the broader cognitive architecture of a persistent cognitive machine through symbolic anchors, thought bundles, dreaming processes, and federated exchange mechanisms, in an embodiment.

The cognitive integration and learning system 150 operates continuously in parallel with other subsystems, providing guidance during real-time processing and engaging in exploratory learning during idle periods to improve processing capabilities over time. A symbolic anchor management stage 405 maintains a set of anchor pairs associating trajectory points with semantic labels such as faces, vehicles, motion onset events, or scene transitions, where each anchor pair links a specific point in a trajectory to a symbolic descriptor that characterizes the semantic content or cognitive significance at that location. The symbolic anchor management stage 405 signals to upsampling and restoration systems which regions of trajectories are cognitively or semantically significant, allowing computational resources to be allocated preferentially to anchor-linked segments when processing budgets are constrained.

Processed trajectories and their associated upsampling configurations flow to a thought bundle caching stage 410 that maintains mappings from trajectories to processing strategies. The thought bundle caching stage 410 stores successful strategy configurations that encode parameters, operation sequences, and settings used during upsampling and restoration of previously processed trajectories, creating a form of procedural memory that supports efficient reuse of effective approaches. When a new trajectory is encountered, the thought bundle caching stage 410 searches the cache for prior trajectories that are similar under a manifold distance metric or semantic similarity measure, retrieves the associated strategy when similarity exceeds a threshold, and adapts the retrieved strategy to the new trajectory. The thought bundle caching stage 410 may use learned embeddings or latent classifiers to determine semantic similarity between trajectories, supporting strategy reuse even when geometric differences exist but semantic content remains consistent across different captures or viewpoints.

During idle cycles when real-time input is not being processed, a dreaming and perturbation stage 415 applies stochastic perturbations to stored trajectories to explore alternative processing approaches. The dreaming and perturbation stage 415 may apply zero-mean Gaussian perturbations in tangent space to latent states, producing perturbed trajectories that deviate from original paths by controlled amounts, or may recombine archived trajectories using stochastic geodesic recombination operators that blend features from multiple stored trajectories to form novel synthetic trajectories. The dreaming and perturbation stage 415 processes these perturbed or recombined trajectories through the upsampling and restoration pipeline, generating results that may reveal improved strategies for handling degradation patterns, occlusion types, or content categories not well-represented in real-time experience.

Results from the dreaming and perturbation stage 415 flow to a strategy evaluation and incorporation stage 420 that assesses the coherence and fidelity of perturbed or recombined processing outcomes. The strategy evaluation and incorporation stage 420 computes reconstruction quality metrics, checks geometric validity of resulting trajectories against manifold constraints, and compares synthesized results against learned priors for plausibility to identify which perturbations or recombinations produced improvements. When a perturbation or recombination yields results that exceed quality thresholds or reveal novel effective approaches, the strategy evaluation and incorporation stage 420 incorporates the discovered strategy into the thought bundle cache maintained by the thought bundle caching stage 410, expanding the system's repertoire of effective processing configurations through offline exploration.

A federated strategy exchange stage 425 supports collaborative learning across multiple persistent cognitive machine instances by exporting and importing manifold-level strategy descriptions. The federated strategy exchange stage 425 exports strategy descriptions that encode geometric operations, parameter configurations, and semantic conditioning approaches in abstract forms not containing pixel data, allowing strategies to be transmitted to remote machines while preserving privacy of original visual content. When importing strategies from remote systems, the federated strategy exchange stage 425 applies fiber map transformations or coordinate transformations to translate strategies from source manifold coordinate systems to local manifold structures, accounting for differences in encoder architectures or training data while preserving core geometric principles. The federated strategy exchange stage 425 may weight contributions by source reliability, giving greater influence to strategies exported by machines that have demonstrated high performance or that operate in similar environments to the receiving system.

The cognitive integration and learning system 150 outputs guidance signals 430 to the manifold-constrained trajectory upsampling system 130 and cross-modal restoration and augmentation system 140 that direct prioritization of processing operations. The guidance signals 430 indicate which trajectory segments are associated with symbolic anchors, enabling concentration of densification and restoration resources on semantically important regions rather than uniform processing across entire trajectories. The cognitive integration and learning system 150 also outputs retrieved strategies 435 from the thought bundle cache that reduce computational overhead by allowing reuse of successful processing configurations when similar trajectories are encountered, and outputs improved generalization capabilities 440 resulting from offline exploration that expand the system's ability to handle novel degradation types or previously unseen combinations of modalities discovered through dreaming processes.

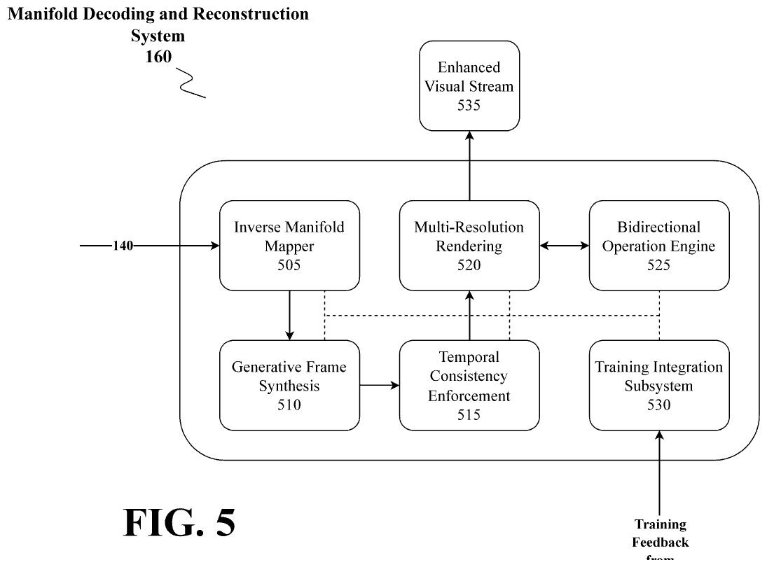

FIG. 5 is a block diagram illustrating an exemplary manifold decoding and reconstruction system 160 that transforms restored and augmented latent trajectories back into observable pixel-space outputs, in an embodiment.

The manifold decoding and reconstruction system 160 receives a restored and augmented trajectory from the cross-modal restoration and augmentation system 140, where the trajectory has been densified through geodesic interpolation, enhanced through cross-modal correlation, and augmented with synthesized detail, all while maintaining geometric validity within the Lorentzian manifold structure. An inverse manifold mapping stage 505 applies a decoder that reconstructs pixel-space sequences from manifold-encoded latent states, transforming trajectories defined in curved latent space back into tensors with dimensions representing temporal length, spatial extent, and channel count suitable for visualization or further processing. The inverse manifold mapping stage 505 may be realized as a deep neural network trained to invert the encoding transformation applied by the manifold embedding system 110, and may consist of deconvolutional layers or learned upsampling layers that expand spatial resolution progressively while incorporating skip connections or cross-attention mechanisms to preserve high-frequency details by referencing earlier encoding stages.

The reconstructed representations flow from the inverse manifold mapping stage 505 to a generative frame synthesis stage 510 that incorporates upsampled and augmented detail through learned decoder networks. The generative frame synthesis stage 510 translates interpolated points from exponential map operations and synthesized detail from generative augmentation into plausible pixel patterns, where the decoder has been trained jointly with the encoder and upsampler to maintain consistency between latent and pixel representations such that geometrically valid latent trajectories correspond to visually coherent frame sequences. The generative frame synthesis stage 510 may utilize adversarial losses or perceptual losses during training to encourage production of frames that exhibit characteristics similar to real captured video, supporting generation of outputs that contain detail beyond the original capture resolution while maintaining visual plausibility.

The synthesized frames pass from the generative frame synthesis stage 510 to a temporal consistency enforcement stage 515 that applies constraints to maintain smooth frame-to-frame transitions in the decoded output. The temporal consistency enforcement stage 515 may compute optical flow alignment between consecutive frames and penalize deviations from smooth flow fields, or may use recurrent connections in the decoder that carry information forward in time to allow each frame to be conditioned on its predecessors. The temporal consistency enforcement stage 515 reduces temporal flicker and maintains smooth motion characteristics that the geodesic trajectory representation is configured to preserve, supporting generation of video sequences where upsampled or augmented content blends seamlessly with original captured content across time.

The temporally consistent frames flow from the temporal consistency enforcement stage 515 to a multi-resolution rendering stage 520 that generates outputs at arbitrary target resolutions beyond the original capture resolution. The multi-resolution rendering stage 520 may include multiple output heads that produce frames at different scales, or may use progressive refinement where an initial coarse frame is iteratively enhanced to reach a target resolution specified by user requirements or application constraints. Because the latent trajectory has been densified and augmented with synthesized detail through operations in systems 130 and 140, the multi-resolution rendering stage 520 can produce output resolutions that exceed input resolution by substantial factors, potentially supporting continuous zoom operations where users can smoothly transition from original capture scale to much finer detail generated through the upsampling and augmentation processes.

A bidirectional operation engine 525 supports both decoding external inputs and generating visual outputs from internal persistent cognitive machine cognitive states. When processing external input, the bidirectional operation engine 525 operates in a forward path where enhanced latent trajectories are transformed back to pixel space for display or downstream use, supporting applications such as live video enhancement, surveillance systems, or medical imaging where degraded inputs require restoration. When generating outputs from internal states, the bidirectional operation engine 525 allows the cognitive architecture to formulate a latent trajectory representing an imagined scene or counterfactual scenario, and renders this internal trajectory to produce visible video, supporting applications such as predictive visualization, planning simulations, or memory reconstruction where the persistent cognitive machine generates visual representations of internally maintained concepts or predictions.

A training integration stage 530 couples the decoder to a composite loss function optimizer that trains the entire system end-to-end. The training integration stage 530 computes a total loss comprising reconstruction fidelity terms measuring correspondence between input and output, geodesic smoothness terms penalizing deviations from geodesic paths, curvature regularization terms preventing manifold distortion, and temporal coherence terms enforcing smooth frame-to-frame transitions, where weighting coefficients control the influence of each regularization term based on task-specific priorities. During training, gradients of the total loss with respect to decoder parameters flow backward through the manifold decoding and reconstruction system 160, then through the cross-modal restoration and augmentation system 140 and manifold-constrained trajectory upsampling system 130, and finally to the manifold embedding system 110, allowing all components to be jointly optimized to work coherently as an integrated pipeline.

The manifold decoding and reconstruction system 160 outputs an enhanced visual stream 535 that exhibits improved resolution relative to the input, restored occlusions filled using cross-modal information, synthesized detail generated through augmentation processes, and maintained causal and semantic coherence through geometric constraints and temporal consistency enforcement. The enhanced visual stream 535 may be rendered for human viewing in applications such as video enhancement or restoration, provided to machine vision systems for object detection or scene understanding in applications requiring high-quality visual input, or fed back into the persistent cognitive machine's cognitive processes for memory storage or reasoning operations where visual information supports higher-level cognitive functions.

The system achieves real-time performance through parallel processing on graphics processing unit or tensor processing unit hardware, decomposing the decoding process into independent operations on spatial tiles or temporal segments that can be processed in parallel to achieve end-to-end latency on the order of less than one hundred milliseconds, supporting applications requiring immediate visual feedback such as live video enhancement, augmented reality displays, or interactive exploration of captured scenes.

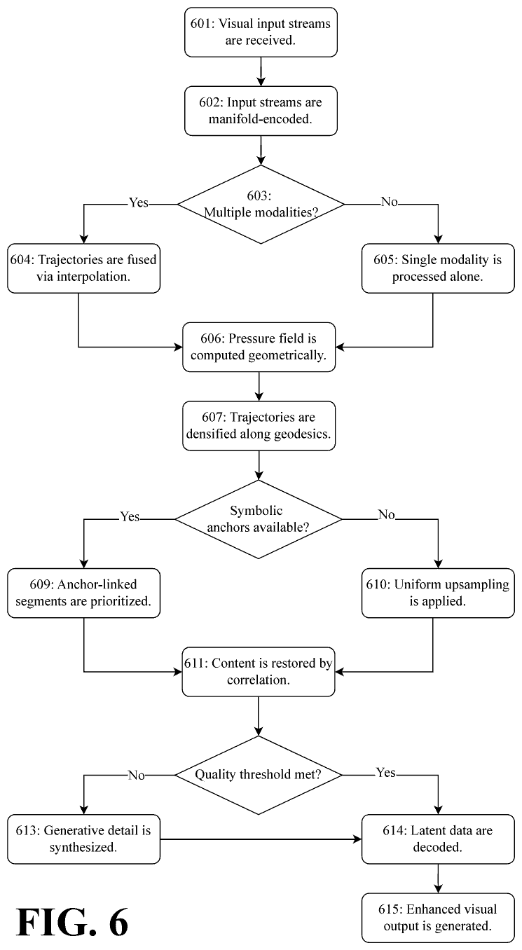

FIG. 6 is a flow diagram illustrating exemplary data flow through a cross-modal and manifold-aware upsampling system in persistent cognitive machines, in an embodiment. The process begins when a manifold embedding system 110 receives visual input streams 601.

The manifold embedding system 110 transforms the visual input streams into latent trajectories within a Lorentzian manifold structure, where the encoding process preserves spatiotemporal causality through enforcement of time-like constraints on trajectory evolution 602. A cross-modal fusion and registration system 120 determines whether multiple sensing modalities or viewpoints are present in the received input streams 603. When multiple modalities are detected, the cross-modal fusion and registration system 120 fuses the trajectories via geodesic interpolation, where quality-weighted combinations of trajectory points produce a unified representation in a shared mesoscale manifold 604. When a single modality is detected, the cross-modal fusion and registration system 120 processes the trajectory without cross-modal fusion operations 605.

The cross-modal fusion and registration system 120 computes a compression pressure field over the manifold by analyzing divergence of latent velocity fields, where the pressure field characterizes semantic density at points along the trajectories 606. A manifold-constrained trajectory upsampling system 130 performs upsampling operations on the trajectory or fused trajectory, where intermediate points are inserted along geodesically valid paths to densify sparse temporal or spatial sampling 607.

The manifold-constrained trajectory upsampling system 130 determines whether symbolic anchors marking semantically significant locations are available from a cognitive integration and learning system 150 at step 608. When symbolic anchors are available, the manifold-constrained trajectory upsampling system 130 concentrates upsampling resources preferentially at trajectory segments associated with anchor locations, where faces, vehicles, text, or other cognitively salient content receive enhanced processing 609. When symbolic anchors are not available, the manifold-constrained trajectory upsampling system 130 applies densification operations with substantially uniform allocation across the trajectory 610.

A cross-modal restoration and augmentation system 140 applies correlation operations to restore degraded content in trajectories by exploiting structural information from supporting modalities or viewpoints, where restoration operations are subject to geodesic distance constraints between restored and supporting trajectories 611. The cross-modal restoration and augmentation system 140 evaluates whether the restored trajectory meets a quality threshold based on reconstruction error, geometric validity, or semantic coherence metrics 612. When the quality threshold is not met, the cross-modal restoration and augmentation system 140 applies a generative model to synthesize detail at scales finer than original capture resolution, where generation is conditioned on manifold geometry and symbolic anchor context to produce plausible fine-scale content 613.

When the quality threshold is met or after generative augmentation is applied, a manifold decoding and reconstruction system 160 decodes the upsampled trajectory to pixel space through inverse manifold mapping operations that transform latent representations back to tensors with spatial and temporal dimensions 614. The manifold decoding and reconstruction system 160 produces enhanced visual output with improved resolution relative to input streams, where the output incorporates restored occlusions, synthesized detail, and maintained temporal coherence through geometric constraints applied during trajectory processing 615.

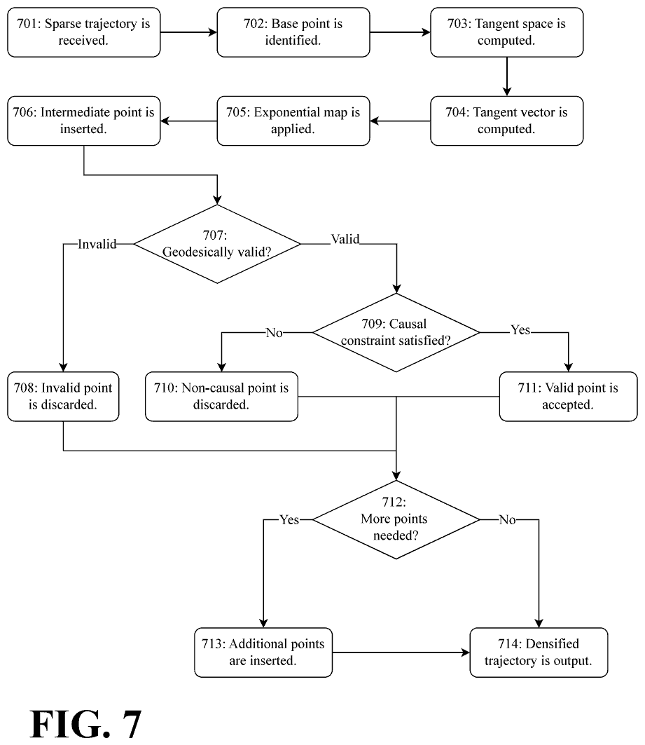

FIG. 7 is a flow diagram illustrating an exemplary manifold-constrained upsampling method for densifying sparse trajectories through geodesically valid interpolation, in an embodiment.

The process begins when a manifold-constrained trajectory upsampling system 130 receives a sparse trajectory from a cross-modal fusion and registration system 120, where the sparse trajectory comprises a sequence of control points representing salient instants or keyframes with insufficient intermediate points for high-resolution reconstruction 701.

The manifold-constrained trajectory upsampling system 130 identifies a base point on the trajectory where an intermediate point may be inserted to increase temporal or spatial sampling density 702. The manifold-constrained trajectory upsampling system 130 computes a tangent space at the identified base point, where the tangent space represents the set of permissible directions for trajectory continuation that respect local manifold geometry 703. The manifold-constrained trajectory upsampling system 130 computes a tangent vector within the tangent space, where the tangent vector specifies a direction of densification based on trajectory curvature, compression pressure values, or symbolic anchor proximity 704. The manifold-constrained trajectory upsampling system 130 applies an exponential map operation that takes the base point and tangent vector to produce an intermediate point along a geodesic path extending from the base point 705.

The manifold-constrained trajectory upsampling system 130 inserts the computed intermediate point into the trajectory between existing control points 706. The manifold-constrained trajectory upsampling system 130 performs a geodesic validity check to determine whether the inserted point maintains smooth evolution according to the geodesic equation and Christoffel symbols derived from the manifold metric 707. When the geodesic validity check indicates the point is invalid, the manifold-constrained trajectory upsampling system 130 discards the point to prevent introduction of geometrically inconsistent content 708. When the geodesic validity check indicates the point is valid, the manifold-constrained trajectory upsampling system 130 evaluates whether the causal constraint is satisfied by verifying that the time-like condition holds for the trajectory derivative at the inserted point 709. When the causal constraint is not satisfied, the manifold-constrained trajectory upsampling system 130 discards the point to prevent retrocausal or non-physical transitions 710. When the causal constraint is satisfied, the manifold-constrained trajectory upsampling system 130 accepts the intermediate point as part of the densified trajectory 711. The manifold-constrained trajectory upsampling system 130 determines whether additional points are needed based on target sampling density, compression pressure distribution, or computational budget constraints 712. When additional points are needed, the manifold-constrained trajectory upsampling system 130 returns to the base point identification stage to insert further intermediate points 713. When sufficient densification has been achieved, the manifold-constrained trajectory upsampling system 130 outputs the densified trajectory with increased temporal and spatial sampling along geodesically valid paths for downstream restoration and augmentation operations 714.

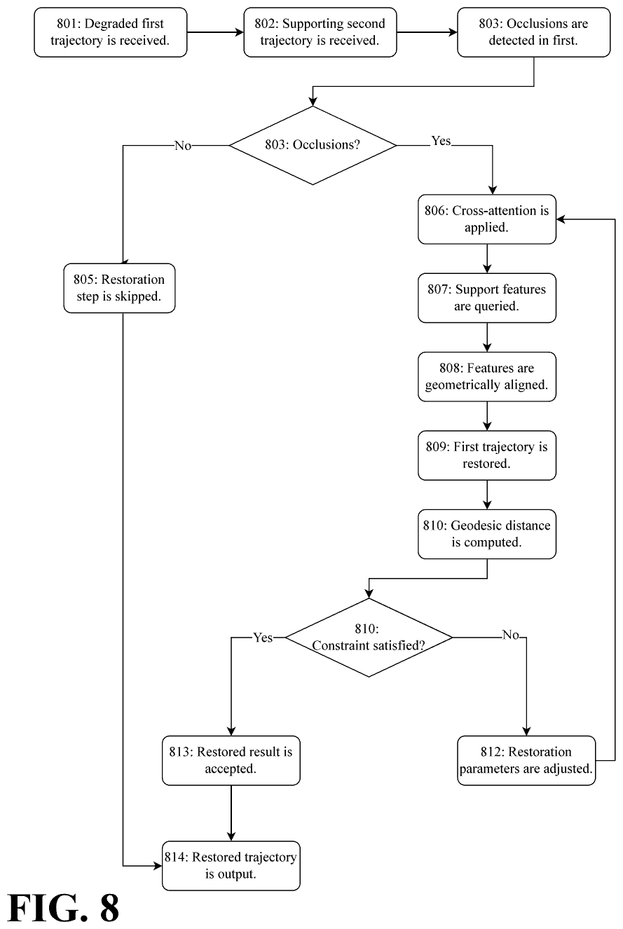

FIG. 8 is a flow diagram illustrating an exemplary cross-modal restoration method for recovering degraded content using structural information from supporting modalities, in an embodiment.

The process begins when a cross-modal restoration and augmentation system 140 receives a degraded first trajectory from a manifold-constrained trajectory upsampling system 130, where the first trajectory may contain occluded regions, compression artifacts, or insufficient detail for target resolution requirements 801. The cross-modal restoration and augmentation system 140 receives a supporting second trajectory derived from a different sensing modality or viewpoint, where the second trajectory may contain structural information not present or degraded in the first trajectory 802. The cross-modal restoration and augmentation system 140 detects occlusions or degraded regions in the first trajectory by analyzing reconstruction error, checking for missing data regions, or identifying areas where quality scores fall below threshold values 803.

The cross-modal restoration and augmentation system 140 determines whether occlusions have been detected in the first trajectory 804. When no occlusions are detected, the cross-modal restoration and augmentation system 140 proceeds without applying cross-modal restoration operations to the first trajectory 805. When occlusions are detected, the cross-modal restoration and augmentation system 140 applies cross-attention mechanisms that enable features from the second trajectory to query and align with features from the first trajectory 806. The cross-modal restoration and augmentation system 140 queries features from the supporting second trajectory at locations corresponding to detected occlusions or degraded regions 807. The cross-modal restoration and augmentation system 140 aligns queried features with the structure of the first trajectory while maintaining geometric compatibility within the shared manifold space 808.

The cross-modal restoration and augmentation system 140 computes a restored first trajectory by incorporating aligned features from the second trajectory into occluded or degraded regions of the first trajectory 809. The cross-modal restoration and augmentation system 140 calculates geodesic distance between the restored first trajectory and the supporting second trajectory to verify geometric consistency 810. The cross-modal restoration and augmentation system 140 evaluates whether the geodesic distance constraint is satisfied by determining if the calculated distance remains below a threshold epsilon value 811. When the geodesic distance constraint is not satisfied, the cross-modal restoration and augmentation system 140 adjusts restoration parameters such as attention weights, feature alignment settings, or correlation strength 812. When the geodesic distance constraint is satisfied, the cross-modal restoration and augmentation system 140 accepts the restored trajectory as geometrically valid and semantically consistent with the supporting modality 813. The cross-modal restoration and augmentation system 140 outputs the restored trajectory for downstream generative augmentation or decoding operations, where the output incorporates recovered structural information from the supporting modality while maintaining geodesic proximity constraints 814.

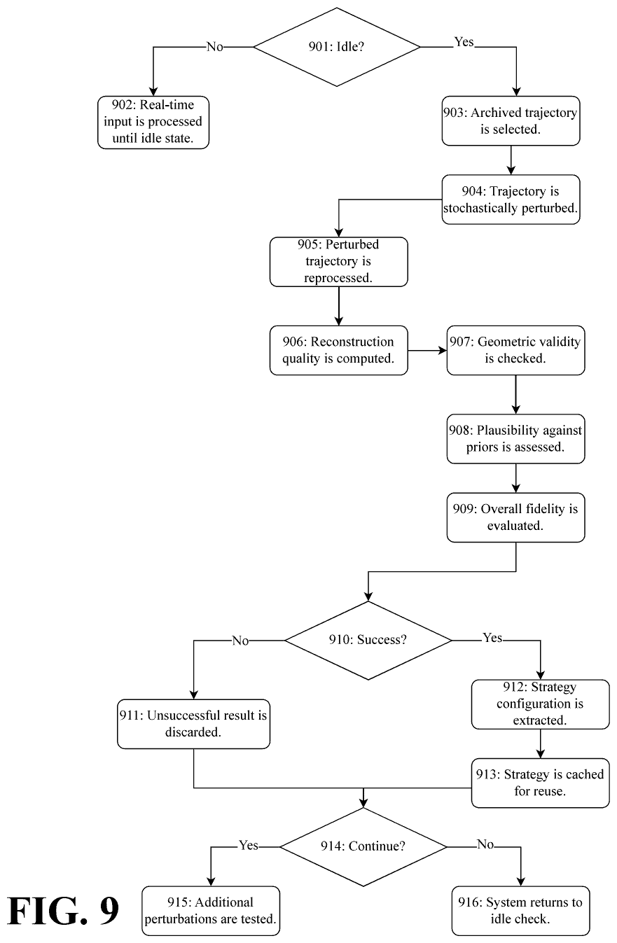

FIG. 9 is a flow diagram illustrating an exemplary offline exploration and caching method for discovering improved upsampling strategies during idle periods, in an embodiment.

The process begins when a cognitive integration and learning system 150 evaluates whether the persistent cognitive machine is in an idle state without real-time input processing demands 901.

When the system is not idle, the cognitive integration and learning system 150 continues real-time processing of external visual input streams 902. When the system is idle, the cognitive integration and learning system 150 selects an archived trajectory from storage, where the archived trajectory represents a previously processed visual sequence or segment 903. The cognitive integration and learning system 150 applies a stochastic perturbation to the archived trajectory by adding zero-mean Gaussian noise in tangent space, where the perturbation magnitude is controlled by a covariance parameter 904.

The cognitive integration and learning system 150 processes the perturbed trajectory through the upsampling pipeline comprising manifold-constrained trajectory upsampling operations and cross-modal restoration operations 905. The cognitive integration and learning system 150 computes reconstruction quality metrics for the results produced from the perturbed trajectory, where metrics may include reconstruction error, perceptual quality scores, or resolution enhancement measures 906. The cognitive integration and learning system 150 checks geometric validity of the perturbed trajectory results by verifying that geodesic constraints and causal ordering are maintained throughout processing 907. The cognitive integration and learning system 150 compares synthesized results against learned priors for plausibility, where priors may encode expected characteristics of specific content categories or visual patterns 908. The cognitive integration and learning system 150 evaluates overall coherence and fidelity of the perturbed trajectory processing results by combining quality metrics, geometric validity checks, and plausibility assessments 909.

The cognitive integration and learning system 150 determines whether the perturbation resulted in a successful strategy that produces improvements relative to baseline processing approaches 910. When the strategy is not successful, the cognitive integration and learning system 150 discards the perturbation results without modifying the thought bundle cache 911. When the strategy is successful, the cognitive integration and learning system 150 extracts a strategy configuration describing the parameters, operations, and settings that produced the improved results 912. The cognitive integration and learning system 150 incorporates the extracted strategy into a thought bundle cache where it can be retrieved and reused when geometrically or semantically similar trajectories are encountered during real-time processing 913. The cognitive integration and learning system 150 determines whether to continue exploration based on available idle time, computational budget, or diversity of cached strategies 914. When continued exploration is desired, the cognitive integration and learning system 150 returns to the trajectory selection stage to test additional perturbations 915. When exploration should be paused, the cognitive integration and learning system 150 returns to the idle state evaluation to monitor for resumption of real-time processing demands 916.

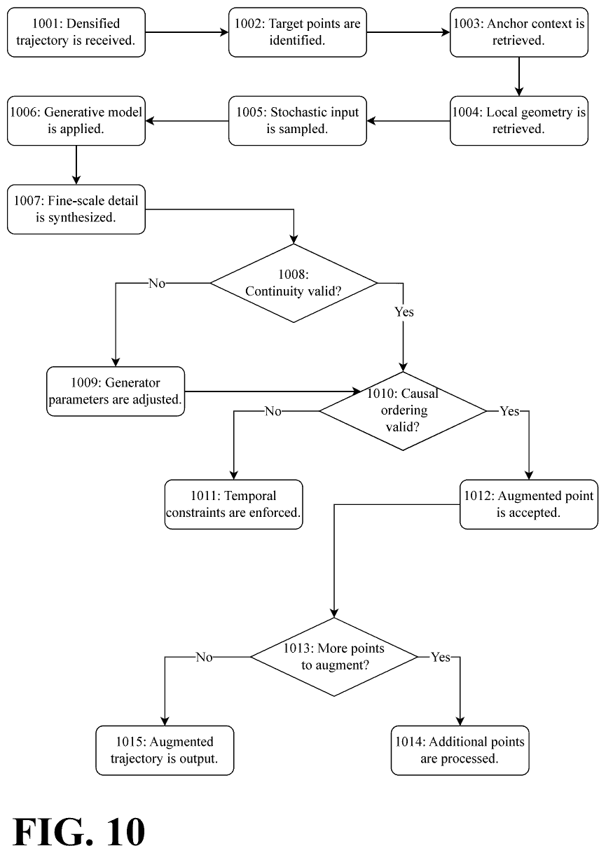

FIG. 10 is a flow diagram illustrating an exemplary generative augmentation method for synthesizing plausible detail beyond original capture resolution, in an embodiment.

The process begins when a cross-modal restoration and augmentation system 140 receives a densified trajectory from a manifold-constrained trajectory upsampling system 130, where the densified trajectory may lack sufficient fine-scale detail for target resolution requirements 1001. The cross-modal restoration and augmentation system 140 identifies points along the trajectory where augmentation may synthesize additional detail, where selection may be based on compression pressure values, symbolic anchor locations, or resolution enhancement goals 1002.

The cross-modal restoration and augmentation system 140 retrieves symbolic anchor context from a cognitive integration and learning system 150, where anchor context provides semantic labels such as face, vehicle, or text that guide generation toward plausible content for the identified category 1003. The cross-modal restoration and augmentation system 140 retrieves local manifold geometry information at the identified points, where geometry information includes metric tensor values, curvature properties, and tangent space structure 1004.

The cross-modal restoration and augmentation system 140 samples a stochastic input from a standard normal distribution, where the stochastic input introduces controlled variability into the generation process 1005. The cross-modal restoration and augmentation system 140 applies a generative model that takes the trajectory point and stochastic input to produce an augmented latent state, where the generative model may utilize latent diffusion or other generative architectures 1006.

The cross-modal restoration and augmentation system 140 synthesizes fine-scale detail at the target points by decoding the augmented latent state to produce texture, micro-motion, or surface characteristics not present in the original capture 1007. The cross-modal restoration and augmentation system 140 evaluates whether geodesic continuity is maintained by verifying that the synthesized detail remains on valid geodesic paths within the manifold structure 1008. When geodesic continuity is not valid, the cross-modal restoration and augmentation system 140 adjusts generator parameters such as conditioning weights, noise scales, or architectural settings 1009. When geodesic continuity is valid, the cross-modal restoration and augmentation system 140 evaluates whether causal ordering is preserved by checking that the time-like constraint holds for the augmented trajectory 1010.

When causal ordering is not valid, the cross-modal restoration and augmentation system 140 adjusts generator parameters to produce content that respects temporal causality 1011. When causal ordering is valid, the cross-modal restoration and augmentation system 140 accepts the augmented trajectory point as geometrically and causally consistent 1012. The cross-modal restoration and augmentation system 140 determines whether additional points require augmentation based on coverage of high-priority regions or achievement of target detail density 1013. When more points require augmentation, the cross-modal restoration and augmentation system 140 returns to the point identification stage to process additional locations 1014. When sufficient augmentation has been achieved, the cross-modal restoration and augmentation system 140 outputs the augmented trajectory with synthesized fine-scale detail for downstream decoding operations 1015.

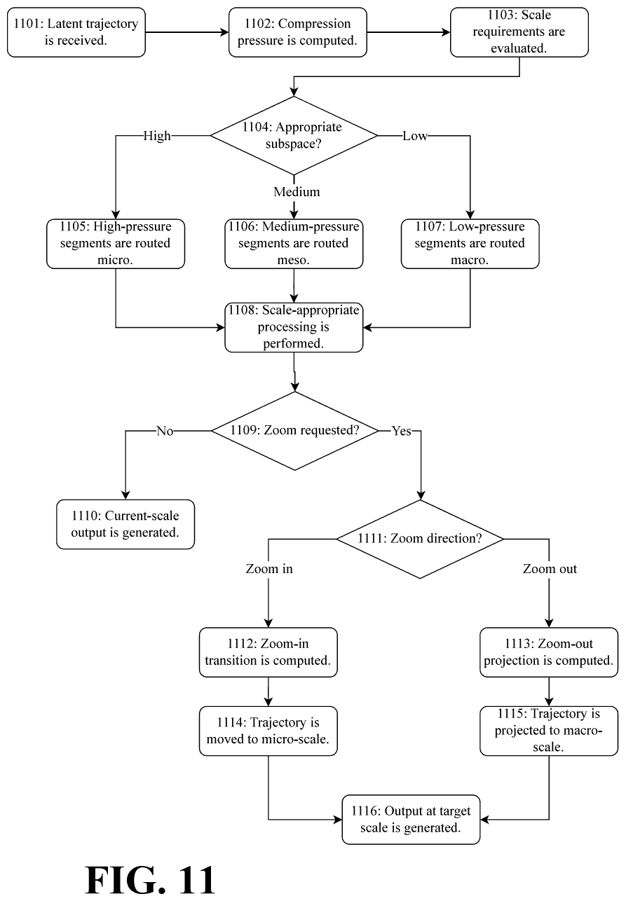

FIG. 11 is a flow diagram illustrating an exemplary hierarchical scale routing method for dynamically allocating trajectories to appropriate resolution subspaces, in an embodiment.

The process begins when a manifold-constrained trajectory upsampling system 130 receives a latent trajectory from a cross-modal fusion and registration system 120, where the trajectory may contain segments requiring processing at different levels of detail 1101. The manifold-constrained trajectory upsampling system 130 computes compression pressure along the trajectory by analyzing divergence of the latent velocity field, where pressure values characterize semantic density and structural complexity at each point 1102. The manifold-constrained trajectory upsampling system 130 evaluates current scale requirements based on the computed pressure values, zoom context from user interaction or system goals, and computational budget constraints 1103. The manifold-constrained trajectory upsampling system 130 selects an appropriate subspace for processing the trajectory segment based on the evaluated requirements 1104.

When high compression pressure is detected, the manifold-constrained trajectory upsampling system 130 routes the trajectory segment to a micro-scale subspace for processing fine detail, texture, and high-frequency content 1105. When medium compression pressure is detected, the manifold-constrained trajectory upsampling system 130 routes the trajectory segment to a meso-scale subspace for processing object-level dynamics and intermediate features 1106. When low compression pressure is detected, the manifold-constrained trajectory upsampling system 130 routes the trajectory segment to a macro-scale subspace for processing global structure and coarse motion patterns 1107.

The manifold-constrained trajectory upsampling system 130 performs scale-appropriate processing operations in the selected subspace, where processing may include densification, feature extraction, or geometric operations suited to the resolution level 1108. The manifold-constrained trajectory upsampling system 130 determines whether a zoom operation has been requested by user input, application requirements, or cognitive priorities 1109. When no zoom operation is requested, the manifold-constrained trajectory upsampling system 130 outputs the trajectory at the current scale for downstream restoration or augmentation operations 1110.

When a zoom operation is requested, the manifold-constrained trajectory upsampling system 130 determines the zoom direction as either zoom-in or zoom-out 1111. When zoom-in is requested, the manifold-constrained trajectory upsampling system 130 computes a scale transition by adding a tangent space displacement to move toward higher resolution, where the displacement lies in the tangent space of the micro-scale subspace 1112. When zoom-out is requested, the manifold-constrained trajectory upsampling system 130 computes a scale transition by applying a projection operator that maps the trajectory to a lower resolution representation 1113. When zooming in, the manifold-constrained trajectory upsampling system 130 moves the trajectory to a higher resolution subspace that supports finer detail synthesis 1114. When zooming out, the manifold-constrained trajectory upsampling system 130 projects the trajectory to a lower resolution subspace that represents coarser structure 1115. The manifold-constrained trajectory upsampling system 130 outputs the trajectory at the target scale after scale transition operations complete, where the output maintains semantic continuity across the scale change 1116.

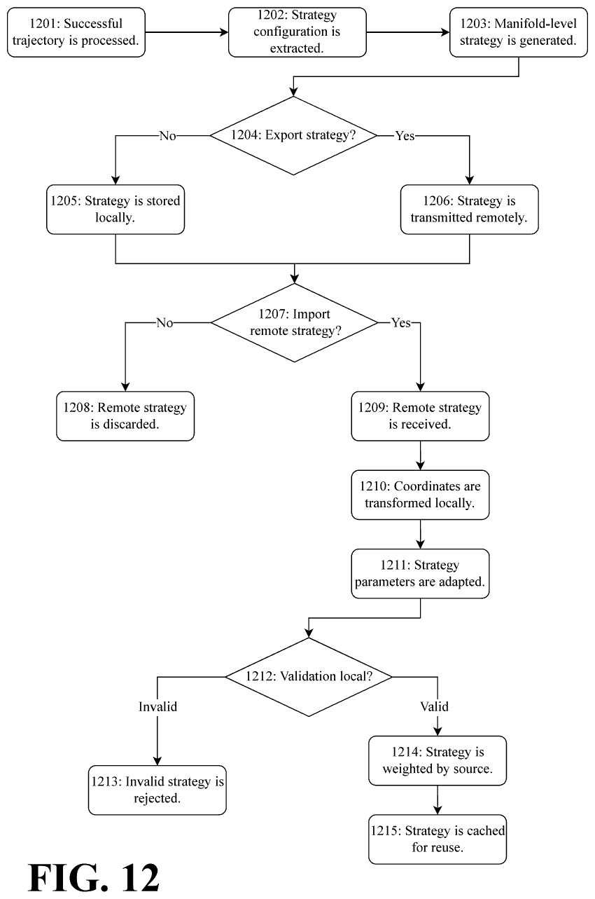

FIG. 12 is a flow diagram illustrating an exemplary federated strategy exchange method for collaborative learning across multiple persistent cognitive machine instances, in an embodiment.

The process begins when a cognitive integration and learning system 150 successfully processes a trajectory through the upsampling and restoration pipeline, where successful processing produces enhanced visual output meeting quality and geometric validity criteria 1201. The cognitive integration and learning system 150 extracts a strategy configuration that describes the parameters, operation sequences, and settings used during the successful processing of the trajectory 1202. The cognitive integration and learning system 150 converts the strategy configuration to a manifold-level representation that encodes geometric operations, semantic conditioning approaches, and processing decisions without including pixel data or original visual content 1203.

The cognitive integration and learning system 150 determines whether to export the strategy to remote persistent cognitive machine systems based on novelty of the strategy, quality improvements achieved, or federation policies 1204. When export is not selected, the cognitive integration and learning system 150 stores the strategy locally in a thought bundle cache for reuse during future processing of similar trajectories 1205. When export is selected, the cognitive integration and learning system 150 transmits the manifold-level strategy description to one or more remote persistent cognitive machine systems via network communication channels 1206.

The cognitive integration and learning system 150 determines whether to import a remote strategy that has been received from another persistent cognitive machine instance in the federation 1207. When import is not selected, the process concludes without incorporating external strategies 1208. When import is selected, the cognitive integration and learning system 150 receives a remote strategy description from a federated persistent cognitive machine system, where the description is expressed in the source system's manifold coordinate framework 1209.

The cognitive integration and learning system 150 applies coordinate transformations to translate the remote strategy from the source manifold coordinate system to the local manifold coordinate system 1210. The cognitive integration and learning system 150 adapts the transformed strategy to the local manifold structure by adjusting parameters to account for differences in encoder architectures, training data distributions, or geometric properties 1211. The cognitive integration and learning system 150 validates the adapted strategy in the local manifold by testing whether it produces geometrically valid trajectories and maintains semantic coherence when applied to local data 1212. When validation indicates the remote strategy is invalid for the local manifold structure, the cognitive integration and learning system 150 rejects the remote strategy without incorporating it into the cache 1213. When validation indicates the remote strategy is valid, the cognitive integration and learning system 150 weights the strategy by source reliability based on performance metrics, reputation scores, or similarity of operating environments between source and local systems 1214.

The cognitive integration and learning system 150 incorporates the validated and weighted remote strategy into the local thought bundle cache, where it becomes available for retrieval and reuse during processing of trajectories that match the strategy's applicability conditions 1215.

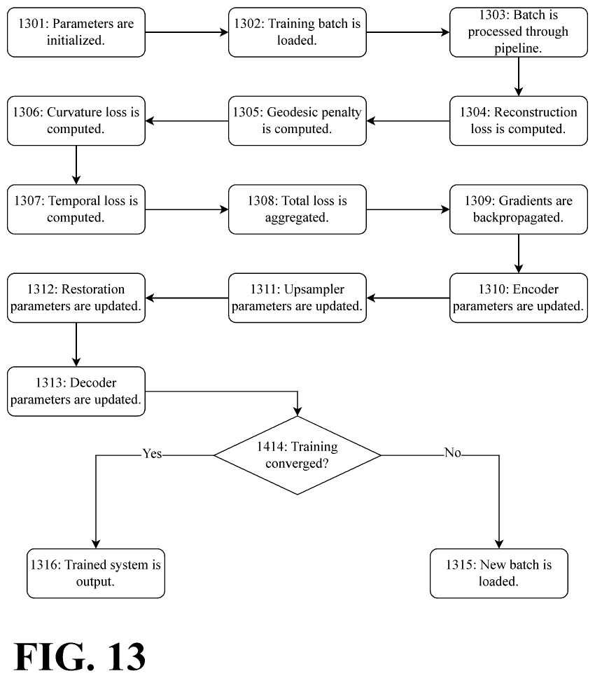

FIG. 13 is a flow diagram illustrating an exemplary joint training method for optimizing encoders, upsamplers, restoration systems, and decoders through end-to-end gradient descent, in an embodiment.

The process begins when a training system initializes encoder and decoder parameters using random initialization, pre-trained weights, or transfer learning from related tasks 1301. The training system loads a training batch of visual data comprising input streams with known ground truth outputs, where the batch may include degraded video sequences, multimodal sensor captures, or synthetic data with controlled degradation patterns 1302. The training system processes the batch through the complete pipeline including manifold embedding, cross-modal fusion, trajectory upsampling, restoration and augmentation, and decoding operations 1303.

The training system computes a reconstruction fidelity loss that measures correspondence between decoded output and ground truth data, where the loss may utilize pixel-wise metrics, perceptual similarity measures, or feature-space distances 1304. The training system computes a geodesic smoothness penalty that penalizes deviations from geodesic paths in the latent trajectories, where the penalty encourages trajectories to evolve along geometrically valid curves within the manifold 1305. The training system computes a curvature regularization loss that prevents excessive manifold distortion by penalizing large curvature values or rapid changes in metric tensor properties 1306.

The training system computes a temporal coherence loss that enforces smooth frame-to-frame transitions in decoded video sequences, where coherence may be measured through optical flow consistency or temporal feature similarity 1307. The training system combines the weighted loss terms into a total loss using weighting coefficients that control the relative influence of reconstruction fidelity, geodesic smoothness, curvature regularization, and temporal coherence based on task-specific priorities 1308. The training system computes gradients of the total loss with respect to all trainable parameters via backpropagation, where gradients flow backward through the decoder, restoration system, upsampling system, fusion system, and encoder 1309.

The training system updates encoder parameters in a manifold embedding system 110 using the computed gradients and an optimization algorithm such as stochastic gradient descent or adaptive moment estimation 1310. The training system updates upsampling system parameters in a manifold-constrained trajectory upsampling system 130, where parameters may include exponential map computation networks, tangent space estimators, or pressure-based routing logic 1311. The training system updates restoration system parameters in a cross-modal restoration and augmentation system 140, where parameters may include cross-attention weights, correlation operators, or generative model components 1312. The training system updates decoder parameters in a manifold decoding and reconstruction system 160, where parameters may include inverse mapping networks, temporal consistency modules, or multi-resolution rendering components 1313.

The training system determines whether training has converged based on validation loss stabilization, reaching a maximum iteration count, or achieving target performance metrics 1314. When training has not converged, the training system returns to the batch loading stage to process additional training data 1315. When training has converged, the training system outputs the trained system with optimized parameters for deployment in visual upsampling and restoration applications 1316.

### Exemplary Computing Environment

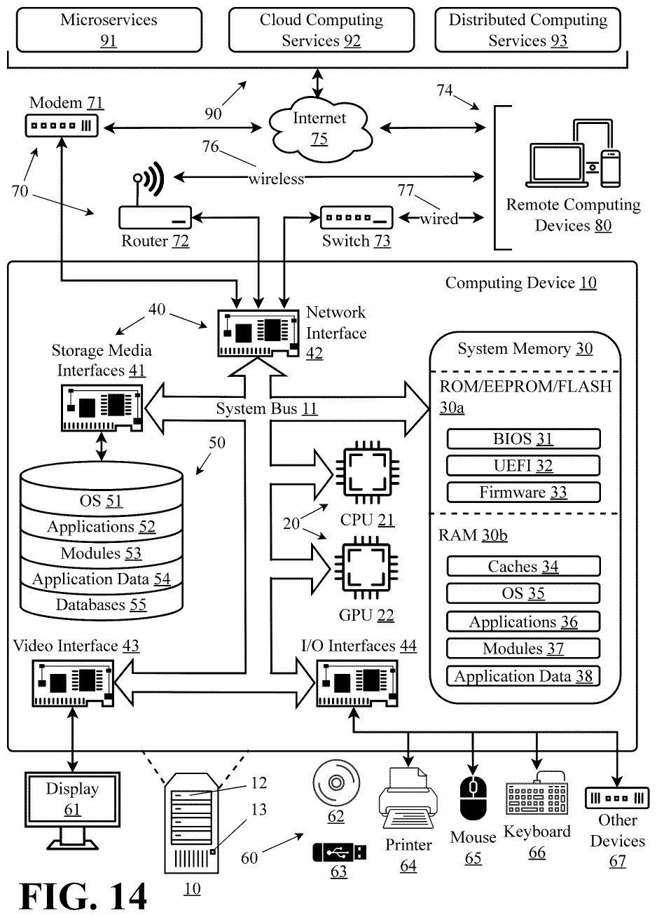

FIG. 14 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and

processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing,

AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system.

Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
encode visual input streams into respective latent trajectories in a Lorentzian manifold using one or more encoders that preserve spatiotemporal causality through enforcement of time-like constraints on trajectory evolution;
compute a compression pressure field within the Lorentzian manifold, the compression pressure field characterizing semantic density at points along the latent trajectories;
perform manifold-constrained upsampling by densifying the latent trajectories through insertion of intermediate points along geodesically valid paths, wherein allocation of densification operations is guided by the compression pressure field;
apply cross-modal correlation to restore degraded content in a first latent trajectory by exploiting structural information from a second latent trajectory derived from a different modality or viewpoint, subject to geodesic distance constraints between the restored first latent trajectory and the second latent trajectory;
integrate symbolic anchors that mark semantically significant locations within the Lorentzian manifold to guide prioritization of upsampling and restoration operations; and
decode the upsampled and restored latent trajectories to generate enhanced visual output having improved resolution relative to the visual input streams while maintaining temporal coherence.

2. The computer system of claim 1, wherein the software instructions further cause the computer system to apply generative augmentation to synthesize detail at scales finer than original capture resolution by applying a generative model to points along the latent trajectories conditioned on manifold geometry and symbolic anchors, wherein the synthesized detail respects geodesic continuity and causal ordering constraints of the Lorentzian manifold.

3. The computer system of claim 1, wherein performing manifold-constrained upsampling comprises computing intermediate trajectory points by applying an exponential map operation that takes a base point on the latent trajectory and a tangent vector at that base point to produce a new point along a geodesic path extending from the base point in a direction specified by the tangent vector.

4. The computer system of claim 1, wherein the software instructions further cause the computer system to dynamically route latent trajectories among hierarchical subspaces representing macro-scale global structure, meso-scale intermediate features, and micro-scale fine detail, wherein the routing is based on compression pressure values and enables bidirectional zoom operations that preserve semantic coherence across scale transitions.

5. The computer system of claim 1, wherein the software instructions further cause the computer system to cache successful upsampling strategy configurations associated with processed trajectories and retrieve cached strategies when encountering geometrically or semantically similar trajectories, thereby creating procedural memory that reduces computational cost for recurring processing patterns.

6. The computer system of claim 5, wherein the software instructions further cause the computer system to perform offline exploration by applying stochastic perturbations to stored trajectories during idle periods, evaluating coherence and fidelity of results from the perturbed trajectories, and incorporating successful perturbations into the cached strategies to expand processing capabilities beyond real-time training.

7. The computer system of claim 5, wherein the software instructions further cause the computer system to export strategy descriptions in manifold-level representations for transmission to remote computer systems without transmitting underlying visual data, and import strategy descriptions from remote computer systems by applying coordinate transformations to adapt the imported strategies to a local manifold structure.

8. The computer system of claim 1, wherein the software instructions further cause the computer system to decode the upsampled and restored latent trajectories using a decoder, and wherein the one or more encoders and the decoder are trained jointly using a composite loss function that includes a reconstruction fidelity term, a geodesic smoothness term that penalizes deviations from geodesic paths, a curvature regularization term, and a temporal coherence term, wherein the terms are weighted to balance reconstruction accuracy with geometric validity.

9. The computer system of claim 1, wherein applying cross-modal correlation comprises using a correlation operator that incorporates cross-attention mechanisms allowing features from the second latent trajectory to query and align with features from the first latent trajectory while maintaining geodesic continuity in the restored first latent trajectory.

10. A computer-implemented method comprising:
encoding visual input streams into respective latent trajectories in a Lorentzian manifold using one or more encoders that preserve spatiotemporal causality through enforcement of time-like constraints on trajectory evolution;
computing a compression pressure field within the Lorentzian manifold, the compression pressure field characterizing semantic density at points along the latent trajectories;
performing manifold-constrained upsampling by densifying the latent trajectories through insertion of intermediate points along geodesically valid paths, wherein allocation of densification operations is guided by the compression pressure field;
applying cross-modal correlation to restore degraded content in a first latent trajectory by exploiting structural information from a second latent trajectory derived from a different modality or viewpoint, subject to geodesic distance constraints between the restored first latent trajectory and the second latent trajectory;
integrating symbolic anchors that mark semantically significant locations within the Lorentzian manifold to guide prioritization of upsampling and restoration operations; and
decoding the upsampled and restored latent trajectories to generate enhanced visual output having improved resolution relative to the visual input streams while maintaining temporal coherence.

11. The method of claim 10, further comprising applying generative augmentation to synthesize detail at scales finer than original capture resolution by applying a generative model to points along the latent trajectories conditioned on manifold geometry and symbolic anchors, wherein the synthesized detail respects geodesic continuity and causal ordering constraints of the Lorentzian manifold.

12. The method of claim 10, wherein performing manifold-constrained upsampling comprises computing intermediate trajectory points by applying an exponential map operation that takes a base point on the latent trajectory and a tangent vector at that base point to produce a new point along a geodesic path extending from the base point in a direction specified by the tangent vector.

13. The method of claim 10, further comprising dynamically routing latent trajectories among hierarchical subspaces representing macro-scale global structure, meso-scale intermediate features, and micro-scale fine detail, wherein the routing is based on compression pressure values and enables bidirectional zoom operations that preserve semantic coherence across scale transitions.

14. The method of claim 10, further comprising caching successful upsampling strategy configurations associated with processed trajectories and retrieving cached strategies when encountering geometrically or semantically similar trajectories, thereby creating procedural memory that reduces computational cost for recurring processing patterns.

15. The method of claim 14, further comprising performing offline exploration by applying stochastic perturbations to stored trajectories during idle periods, evaluating coherence and fidelity of results from the perturbed trajectories, and incorporating successful perturbations into the cached strategies to expand processing capabilities beyond real-time training.

16. The method of claim 14, further comprising exporting strategy descriptions in manifold-level representations for transmission to remote computer systems without transmitting underlying visual data, and importing strategy descriptions from remote computer systems by applying coordinate transformations to adapt the imported strategies to a local manifold structure.

17. The method of claim 10, further comprising decoding the upsampled and restored latent trajectories using a decoder, and wherein the one or more encoders and the decoder are trained jointly using a composite loss function that includes a reconstruction fidelity term, a geodesic smoothness term that penalizes deviations from geodesic paths, a curvature regularization term, and a temporal coherence term, wherein the terms are weighted to balance reconstruction accuracy with geometric validity.

18. The method of claim 10, wherein applying cross-modal correlation comprises using a correlation operator that incorporates cross-attention mechanisms allowing features from the second latent trajectory to query and align with features from the first latent trajectory while maintaining geodesic continuity in the restored first latent trajectory.
